(19) United States
(12) Patent Application Publication
(10) Pub. No.: US 2025/0377454 A1
(43) Pub. Date: Dec. 11, 2025

(54) SYSTEM AND METHOD FOR MULTI-MODE RADAR OPERATION FOR AUTONOMOUS AIRCRAFT

(71) Applicant: Reliable Robotics Corporation, Mountain View, CA (US)

(72) Inventors: Marc Pos, Duvall, WA (US); Juerg Frefel, Cupertino, CA (US); Brandon Suarez, San Diego, CA (US)

(21) Appl. No.: 18/740,344

(22) Filed: Jun. 11, 2024

(51) Int. Cl. G01S 13/934; G01S 7/03; G01S 13/02; G05D 1/242; G05D 109/22; G05D 111/30

(52) U.S. Cl. CPC G01S 13/934; G01S 7/03; G05D 1/242; G01S 2013/0263; G05D 2109/22; G05D 2111/30

(57) ABSTRACT

A method of operating a multi-mode radar system during multiple phases of autonomous aircraft operation may include, at an aircraft configured for autonomous operations and including a multi-mode radar system, the multi-mode radar system including a two-dimensional array of antenna elements: during an autonomous taxiing phase, operating the multi-mode radar system in a first radar mode to detect ground-based objects, and in response to a prediction of a collision between a ground-based object and the aircraft, executing a ground maneuver to change a direction of travel of the aircraft over ground. The method may further include, during an autonomous flight phase, operating the multi-mode radar system in a second radar mode to detect airborne objects, and in response to a prediction of a collision between an airborne object and the aircraft, executing a flight maneuver to change a direction of flight of the aircraft.

### TECHNICAL FIELD

The present disclosure is generally directed to radar systems for aircraft, and more specifically, to multi-mode radar systems that are operated in different modes during different phases of autonomous aircraft operations.

### BACKGROUND

Traditionally, aircraft are manually piloted by an onboard human who is able to directly operate aircraft controls and monitor flight conditions during flight. Increasingly, aircraft may include systems that facilitate autonomous flight operations. Autonomous flight may be performed with or without onboard crew, using onboard sensors and control systems to operate the aircraft's functions. The systems and techniques described herein may facilitate unmanned flight operations.

### SUMMARY

A method of operating a multi-mode radar system during multiple phases of autonomous aircraft operation may include, at an aircraft configured for autonomous operations and including a multi-mode radar system, the multi-mode radar system including a two-dimensional array of antenna elements: during an autonomous taxiing phase, operating the multi-mode radar system in a first radar mode to detect ground-based objects, including operating a first subset of the two-dimensional array of antenna elements and a second subset of the two-dimensional array of antenna elements in a transmit mode, the first subset of the two-dimensional array of antenna elements different from the second subset of the two-dimensional array of antenna elements, and while operating the first and the second subsets of the two-dimensional array of antenna elements in the transmit mode, operating a third subset of the two-dimensional array of antenna elements and a fourth subset of the two-dimensional array of antenna elements in a receive mode, the third subset of the two-dimensional array of antenna elements different from the fourth subset of the two-dimensional array of antenna elements. The method may further include, based at least in part on a first set of signals received by the third subset and the fourth subset of the two-dimensional array of antenna elements, detecting a first position of a ground-based object, and in response to a prediction of a collision between the ground-based object and the aircraft, the prediction based at least in part on the first position of the ground-based object, executing a ground maneuver to change a direction of travel of the aircraft over ground. The method may further include, during an autonomous flight phase, operating the multi-mode radar system in a second radar mode to detect airborne objects, including operating the two-dimensional array of antenna elements in the transmit mode for a first duration, and after the first duration, operating the two-dimensional array of antenna elements in the receive mode for a second duration. The method may further include, based at least in part on a second set of signals received by the two-dimensional array of antenna elements when operating in the receive mode, detecting a second position of an airborne object, and in response to a prediction of a collision between the airborne object and the aircraft, the prediction based at least in part on the second position of the airborne object, executing a flight maneuver to change a direction of flight of the aircraft.

The method may further include, during an autonomous takeoff phase, alternating between operating the multi-mode radar system in the first radar mode and operating the multi-mode radar system in the second radar mode.

The method may further include, during the autonomous taxiing phase, causing the aircraft to traverse a predefined trajectory over ground, and the prediction of the collision between the ground-based object and the aircraft may be based at least in part on a determination that the predefined trajectory intersects at least one of the first position of the ground-based object or a predicted future position of the ground-based object. The predefined trajectory may be a predefined first trajectory, the method may further include after detecting the first position of the ground-based object, detecting a third position of the ground-based object, and determining a second trajectory of the ground-based object based at least in part on the first position of the ground-based object and the third position of the ground-based object, and the predicted future position of the ground-based object may be determined based at least in part on the second trajectory of the ground-based object.

The first subset of the array of antenna elements may include a first one-dimensional array of antenna elements, and the second subset of the array of antenna elements may include a second one-dimensional array of antenna elements. Operating the first one-dimensional array in the transmit mode may include transmitting, with the first one-dimensional array, a first signal having a first waveform, and operating the second one-dimensional array in the transmit mode may include transmitting, with the second one-dimensional array, a second signal having a second waveform different from the first waveform. The third subset of the array of antenna elements may include a third one-dimensional array of antenna elements, and the fourth subset of the array of antenna elements may include a fourth one-dimensional array of antenna elements.

A method of operating a multi-mode radar system during multiple phases of autonomous aircraft operation, the multi-mode radar system including an array of antenna elements, may include: during an autonomous ground transit phase, operating the multi-mode radar system in a first radar mode to detect ground-based objects, including causing a first subset of the array of antenna elements to emit a first signal, causing a second subset of the array of antenna elements to emit a second signal different from the first signal, the second subset of the array of antenna elements different from the first subset of the array of antenna elements, and, while the first subset of the array of antenna elements is emitting the first signal and while the second subset of the array of antenna elements is emitting the second signal: receiving, with a third subset of the array of antenna elements, first reflected portions of the first and second signals, and receiving, with a fourth subset of the array of antenna elements, second reflected portions of the first and second signals, the fourth subset of the array of antenna elements spatially separated from the third subset of the array of antenna elements. The first signal may have a first waveform, and the second signal may have a second waveform different from the first waveform. The method may further include detecting a first position of a ground-based object based at least in part on the first reflected portions and the second reflected portions of the first and second signals and changing at least one of a speed or a direction of the aircraft over ground during the autonomous ground transit phase based at least in part on the position of the ground-based object. The method may further include, during an autonomous flight phase, operating the multi-mode radar system in a second radar mode to detect airborne objects, including causing the array of antenna elements to emit a third signal, causing the array of antenna elements to cease emitting the third signal, and while the array of antenna elements has ceased emitting the third signal, receiving, with the array of antenna elements, a reflected portion of the third signal. The method may further include detecting a second position of an airborne object based at least in part on the reflected portion of the third signal, and changing at least one of a speed or a direction of the aircraft through the air during the autonomous flight phase based at least in part on the position of the airborne object.

Changing at least one of a speed or a direction of the aircraft over ground during the autonomous ground transit phase may occur in response to a determination that a trajectory of the aircraft over ground intersects the ground-based object. Changing at least one of a speed or a direction of the aircraft through the air during the autonomous flight phase may occur in response to a determination that a trajectory of the aircraft through the air intersects the ground-based object.

Operating the multi-mode radar system in the first radar mode may further include, while the first subset of the array of antenna elements is emitting the first signal and while the second subset of the array of antenna elements is emitting the second signal, receiving, with a fifth subset of the array of antenna elements, third reflected portions of the first and second signals, and receiving, with a sixth subset of the array of antenna elements, fourth reflected portions of the first and second signals.

The method may further include, during an autonomous takeoff phase, alternating between operating the multi-mode radar system in the first radar mode and operating the multi-mode radar system in the second radar mode. The method may further include, during an autonomous landing phase, alternating between operating the multi-mode radar system in the first radar mode and operating the multi-mode radar system in the second radar mode.

The second position may specify a distance between the aircraft and the airborne object, and the method may further include, during the autonomous flight phase, in accordance with a determination that the distance between the aircraft and the airborne object satisfies a distance condition, transitioning from operating the multi-mode radar system in the second radar mode to operating the multi-mode radar system in the first radar mode, and detecting a second position of the airborne object with the multi-mode radar system in the first radar mode.

A multi-mode radar system for an autonomous aircraft may include a radar array including a two-dimensional array of antenna elements arranged in a set of rows and a set of columns, and a radar controller coupled to the two-dimensional array of antenna elements and configured to operate the radar array according to a first radar mode during an autonomous ground transit phase and according a second radar mode during an autonomous flight phase. Operating the radar array according to the first radar mode may include causing at least a portion of a first column of antenna elements within the two-dimensional array of antenna elements to emit a first signal, causing at least a portion of a second column of antenna elements within the two-dimensional array of antenna elements to emit a second signal. Operating the radar array according to the first radar mode may further include, while the first and second signals are being emitted, receiving, with at least a portion of a third column of antenna elements within the two-dimensional array of antenna elements, a first reflected portion of the first signal and a first reflected portion of the second signal, and receiving, with at least a portion of a fourth column of antenna elements within the two-dimensional array of antenna elements, a second reflected portion of the first signal and a second reflected portion of the second signal, and detecting, based at least in part on a time difference of arrival of the first reflected portion of the first signal and the second reflected portion of the first signal, a first position of a ground-based object relative to the multi-mode radar system. Operating the radar array according to the second radar mode may include causing the two-dimensional array of antenna elements to emit a third signal, causing the two-dimensional array of antenna elements to cease emitting the third signal, while the two-dimensional array of antenna elements have ceased emitting the third signal, receiving, with the two-dimensional array of antenna elements, a reflected portion of the third signal, and detecting a second position of an airborne object relative to the multi-mode radar system based at least in part on the reflected portion of the third signal.

The first column of antenna elements may be adjacent the second column of antenna elements. The third column of antenna elements may be adjacent the fourth column of antenna elements.

Operating the radar two-dimensional array according to the first radar mode may further include, while the first and second signals are being emitted, receiving, with at least a portion of a fifth column of antenna elements within the two-dimensional array of antenna elements, third reflected portions of the first and second signals, and receiving, with at least a portion of a sixth column of antenna elements within the two-dimensional array of antenna elements, fourth reflected portions of the first and second signals. Operating the radar array according to the first radar mode may further include, while the first and second signals are being emitted, a portion of the antenna elements within the two-dimensional array of antenna elements are neither emitting nor receiving signals.

### BRIEF DESCRIPTION OF THE DRAWINGS

FIG. 1 depicts an example aircraft operation system.

FIG. 2 depicts an example ground station for communicating with an aircraft.

FIGS. 3A-3B depict an aircraft operating a multi-mode radar system during an autonomous ground traversal operation.

FIGS. 3C-3D depict an aircraft operating a multi-mode radar system during an autonomous flight operation.

FIG. 4A depicts an example array of antenna elements operating in a pulsed mode.

FIG. 4B depicts an example array of antenna elements operating in a multiple in multiple out mode.

FIG. 4C depicts an example array of antenna elements operating in a continuous wave mode.

FIG. 5A depicts an aircraft operating a multi-mode radar system in ground, transition, and flight phases of an autonomous mission.

FIG. 5B depicts multi-mode radar systems in aircraft-based and ground-based installations.

FIG. 6 depicts an example aircraft with multi-mode radar systems.

FIGS. 7A-7F depict example antenna element configurations for a multi-mode radar system.

FIG. 8 depicts a schematic view of an example ground station in communication with an aircraft.

FIG. 9 depicts an example cockpit of an aircraft.

FIG. 10 depicts a schematic of an example onboard system of an aircraft.

FIG. 11 depicts an example data flow between a ground station and an aircraft.

FIG. 12 depicts an example system for communicating with an aircraft from a ground station.

FIG. 13 depicts an example security system for authenticating flight plans and instructions provided by a ground station to an aircraft.

FIG. 14 depicts a flow chart of an example operation for operating a multi-mode radar system.

FIG. 15 depicts an example electronic device.

While the invention as claimed is amenable to various modifications and alternative forms, specific embodiments are shown by way of example in the drawings and are described in detail. It should be understood, however, that the drawings and detailed description are not intended to limit the invention to the particular form disclosed. The intention is to cover all modifications, equivalents, and alternatives falling within the scope of the present invention as defined by the appended claims.

### DETAILED DESCRIPTION OF THE EMBODIMENTS

In the following description numerous specific details are set forth in order to provide a thorough understanding of the claimed invention. It will be apparent, however, that the claimed invention may be practiced without these specific details. In some instances, well-known structures and devices are shown in block diagram form in order to avoid unnecessary obscuring.

The present disclosure is generally directed to a multi-mode radar system that can be used in different modes during different phases of autonomous aircraft operations in order to provide object detection functionality that is particularly suited to that particular flight mode. The multi-mode radar systems described herein may also be employed in ground-based applications to provide object detection functionality that is adaptable to different applications.

In particular, autonomous flight operations as described herein may include an aircraft automatically following or traversing a validated route (e.g., without real-time pilot control). A validated route may define a path or trajectory (e.g., the complete trajectory through three-dimensional space) between an origin and a destination, and which satisfies one or more validation criteria. The validated route may include and/or specify all aircraft maneuvers and operations from an origin static location (e.g., hanger, apron, ramp, parking spot, etc.) to a destination static location (e.g., hanger, apron, ramp, parking spot, etc.), and may include departure taxiing, takeoff, flight, landing, and arrival taxiing, and any other aircraft operations or maneuvers, all of which may be executed autonomously (e.g., without an onboard operator, and/or without input from an onboard operator).

To facilitate autonomous operations, the aircraft must be capable of detecting and reacting to obstacles or other objects or events that may affect their operations. For example, while a validated route may be free of known obstacles (e.g., buildings, mountains, terrain, etc.), real-world environments where the aircraft operate are more variable and including changing conditions. For example, while taxiing from a parking location to a runway, the autonomous aircraft may encounter another aircraft, vehicle, or person, such that the autonomous aircraft may come close to or otherwise be affected by the presence of the object. As another example, while flying along a predetermined path, the autonomous aircraft may encounter another aircraft that may approach the autonomous aircraft. In such cases, the autonomous aircraft should detect the other object (e.g., detect a position of the object), determine whether it needs to take corrective action (e.g., change its trajectory), and take such action if necessary. While radar systems may be used to detect airborne or ground-based objects, a radar system that is capable of detecting airborne objects may not be well suited to detecting ground-based objects, and vise versa. Additionally, the detection capabilities (e.g., position resolution, refresh rate, range, etc.) of different types of radar may render them inadequate for certain applications or performance targets. For example, a radar with a short detection range (e.g., 250 meters) may not be suitable for detecting nearby aircraft during flight.

Described herein are multi-mode radar systems that can be used in different modes during different phases of autonomous aircraft operation. For example, and as described herein, a multi-mode radar system may include an array of antenna elements in which each antenna element can be operated in a transmit mode or a receive mode. Due to the individual addressability and control of each antenna element, the radar system may employ different groups of antenna elements, and operate them in different modes, based on the particular object-detection requirements during a given phase of autonomous flight.

For example, during ground-based phases (e.g., departure and arrival taxiing), it may be valuable to identify nearby objects (e.g., within 200 meters, or another suitable range), with a high degree of positional accuracy and with a high refresh rate (e.g., a fast or rapid refresh rate). In this way, the aircraft can detect and react to the quickly changing environment of relatively smaller objects that may be encountered on the tarmac (e.g., people, airport vehicles, traffic cones or other markers or barricades, jetways, and the like), and that may change in rapid and unexpected ways near the aircraft (e.g., a person running across the aircraft's route). In order to provide effective object detection during this phase of operations, the radar system may operate in a mode in which at least two subsets of the antenna elements are continuously transmitting, while at least two subsets are continuously receiving (such as in a multiple input multiple output or “MIMO” radar mode). This radar mode may provide continuous object detection and a high degree of spatial resolution, which may be well suited to detecting ground-based objects (which may include smaller and nearer objects than an aircraft typically encounters in the air). Additionally, because only some of the antenna elements are transmitting, the overall power output of the radar system (e.g., the power of the radio frequency (RF) fields being emitted) may be reduced, thereby improving safety for nearby individuals.

During airborne phases of a flight, it may be valuable to identify more distant objects, weather, or other events or phenomenon (e.g., within about 3 miles, within about 6 miles, without about 10 miles, within about 20 miles, within about 100 miles, etc.), while the refresh rate need not be as rapid and the ability to detect close objects (e.g., 20 feet from the aircraft) may be less important. In this way, the aircraft can detect other aircraft or airborne objects at a sufficiently long distance to allow the aircraft to perform safe flight maneuvers to avoid any adverse encounter, such as a collision. In order to provide effective object detection during this phase of operations, the radar system may operate in a pulsed radar mode, in which a signal (e.g., an RF pulse) is transmitted (optionally using every antenna element in the array), and then the transmission ceases and the antenna elements are used to receive a reflection of the pulse (e.g., a reflection from an airborne or other object). This radar mode may provide object detection at a long range that will allow the autonomous aircraft to evaluate the potential risk of the airborne object and take appropriate action (e.g., changing its route) to mitigate the risk. Additionally, because people are generally not in the range of the pulsed radar signals, the radar can be operated at higher output power with less risk to bystanders.

Because the multi-mode radar can be operated in different detection modes during different operations, all of the detection functions can be provided by a single radar system on an aircraft, thereby reducing weight, expense, and complexity, while also providing comprehensive object detection for very different types of aircraft operations.

The multi-mode radars described herein may also be configured to alternate between its operational modes under certain circumstances. For example, during an autonomous takeoff phase, the radar may alternate between the MIMO mode and the pulsed mode (e.g., on a periodic or other basis). In this way, the aircraft can maintain effective scanning of the ground and the immediate surroundings of the aircraft (e.g., to maintain object detection capabilities while the vehicle is on or near the ground), while also scanning the air and more distant regions to maintain effective scanning of the airspace where the aircraft is headed. A similar alternating scheme may be used during an autonomous landing operation. In some cases, the radar may switch between modes during other operations or in response to other events. For example, the radar may be configured to change from a pulsed mode to a MIMO mode (or from another long-range sensing mode to another short-range sensing mode) in response to detecting an object within a threshold (e.g., small) distance to the aircraft, or in response to detecting that an object is likely to become close to the aircraft quickly. As another example, the radar may be configured to change between different MIMO modes in response to detecting an object within a threshold distance (e.g., using different groups of transmitting and receiving elements, different frequencies, different numbers of transmitting and/or receiving elements, and the like).

The multi-mode radar system may provide information about the position of objects (e.g., airborne and/or ground-based objects) to an aircraft computing system of the aircraft, or an aircraft operation system more generally, and the aircraft computing system may perform certain operations based on the position information. For example, the aircraft computing system may determine whether a detected object presents a collision risk. If so, the aircraft computing system may modify its current route to avoid the potential collision; if not, the aircraft computing system may maintain its current route.

While the foregoing examples describe a multi-mode radar system switching between a MIMO radar mode and a pulsed radar mode, the multi-mode radar system may be operable in other modes as well, and may switch between such modes under certain conditions (e.g., for different aircraft operational modes or phases). For example, the ability to discretely operate each antenna element of the radar array may allow the multi-mode radar system to operate in a continuous wave mode, a frequency-modulated continuous-wave mode, frequency-modulated interrupted continuous-wave mode, or other modes.

Autonomous flight operations as described herein may include an aircraft automatically following or traversing a validated route (e.g., without onboard operator intervention or control). A validated route may define a path or trajectory (e.g., the complete trajectory through three-dimensional space) between an origin and a destination, and which satisfies one or more validation criteria. The validated route may include and/or specify all aircraft maneuvers and operations from an origin static location (e.g., hanger, apron, ramp, parking spot, etc.) to a destination static location (e.g., hanger, apron, ramp, parking spot, etc.), and may include departure taxiing, takeoff, flight, landing, and arrival taxiing, and any other aircraft operations or maneuvers.

The validation criteria may include, for example, a requirement that the route does not intersect any known obstacles (e.g., no collisions with terrain, buildings, etc.), a requirement that the route meets any applicable regulations, laws, or other guidelines, or a requirement that the route does not encounter known or predicted weather conditions. Other criteria and/or combinations of criteria are also contemplated.

The validated route may define or incorporate various flight parameters, including the particular trajectory to be traversed (including altitude), the aircraft speed along the route, route waypoints and associated arrival times, aircraft attitude or other maneuvers, takeoff and landing operations, and the like. In some cases, a validated route may provide all of the information necessary for the aircraft to autonomously traverse the route (and/or the trajectory defined by the route) without an onboard operator and/or without intervention or control from an onboard operator. Thus, validated routes may provide a basis for safe and efficient autonomous flight operations.

While traversing a validated route, which may be referred to as a primary route, the aircraft may autonomously control any and all necessary aircraft systems to maintain the aircraft on the validated route. For example, the aircraft may control the propulsion system and flight control surfaces to keep the aircraft at the target time and location values defined by the validated route. Such autonomous flight operations may be performed by an uncrewed aircraft, or by an aircraft with an onboard operator.

While a validated route may be preconfigured so that it does not intersect obstacles, the validated route may not be able to account for all real-world or changing conditions, such as vehicular or human traffic, the addition or removal of manmade obstacles, airborne traffic, weather, and the like. Accordingly, and as described herein, information from a multi-mode radar system onboard an aircraft (and/or in ground installations) may be used by an aircraft computing system to determine whether a route needs to be modified or temporarily (or permanently) deviated from in order to account for a detected object. For example, if a validated route would lead to a potential adverse encounter (e.g., collision) with a parked aircraft or vehicle, the validated route may be updated (and/or a validated route deviation or modification may be generated) with a path that avoids the obstacle. Similar operations may occur during airborne phases of a route.

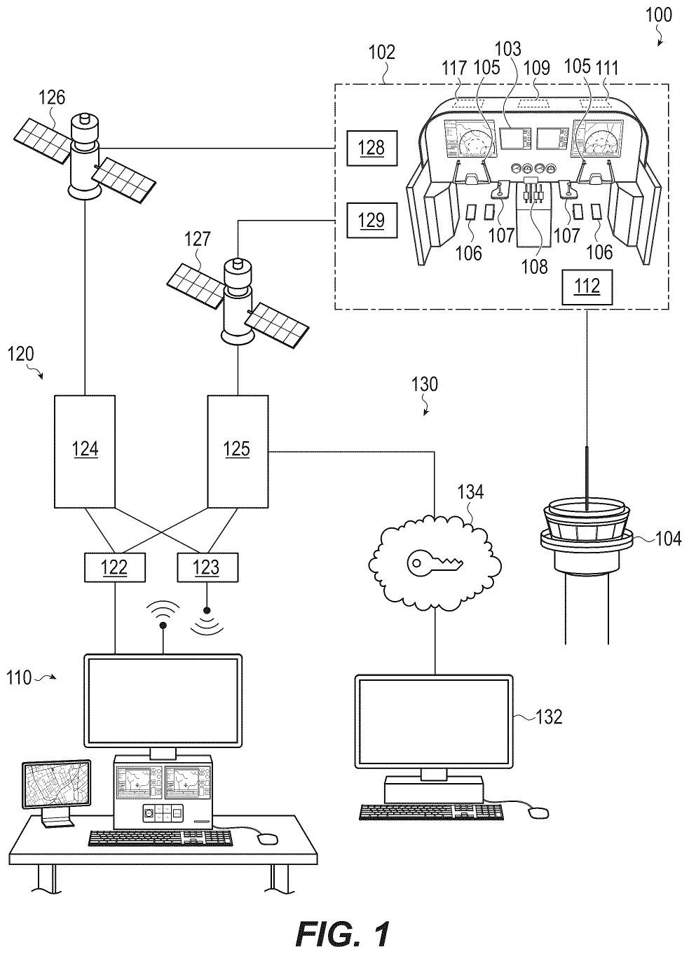

FIG. 1 depicts an example system with an aircraft, which may be crewed or uncrewed, and a ground station, which may be operated by a remote pilot or other operator. Specifically, FIG. 1 depicts an aircraft operation system 100 that includes an aircraft 102 that may be remotely piloted or remotely monitored or controlled by a ground station 110, or which may include onboard crew or operators. As described herein, the aircraft 102 may operate in an autonomous flight mode even when onboard crew is present, and the aircraft 102 may allow the onboard crew to propose modifications or deviations to the validated route, which are then validated and executed by the aircraft 102 using its autonomous flight capabilities and systems.

The ground station 110 may also be referred to as a terminal device, remote terminal, remote control station, ground-based controller, ground-based facility, or simply a controller. Communications between the ground station 110 and the aircraft 102 may be conducted using a communication network 120 having various network elements, described herein. The communications may also be conducted in conjunction with a security system 130, which may be partially or wholly integrated with the communication network 120. The system 100 may also include additional elements including an air traffic control (ATC) facility 104, other ground-based systems, and other aircraft (crewed and uncrewed). The aircraft 102 may communicate with the ATC facility 104 using a radio-frequency (RF) communication module 112, which may include an RF transceiver and other communications electronics configured for wireless communications with an ATC facility 104, other aircraft, or other external devices.

As described herein, the aircraft 102 may be an airplane, rotorcraft, powered lift, glider, lighter-than-air craft, or other current or future category of aircraft. The aircraft 102 may be adapted for cargo or non-passenger service or, alternatively, may be adapted to carry one or more human passengers or both human and cargo service. The aircraft 102 may be configured for (or may be modified or retrofitted to enable) fully autonomous, semi-autonomous, and/or manually operated flight modes, and may be configured for uncrewed flight, remotely operated or monitored flight, or crewed flight. In the present example, the aircraft 102 is a fixed-wing powered airplane, though this is merely for explanation, and the concepts described herein may be applied to other types of aircraft, as described above.

The aircraft 102 is equipped with a flight controller 109 and controls that are configured to operate the propulsion system and various flight control surfaces of the aircraft 102 such as ailerons, an elevator, a rudder, flaps, spoilers, slats, and air brakes. The flight controller 109 may also be configured to control the aircraft propulsion system including, without limitation, piston propeller engines, turboprop engines, turbojet engines, turbofan engines, or ramjet engines. The flight controller 109 may also be adapted to control ground or land-based operations including taxiing, parking, and other pre-flight and post-flight maneuvers as well as operate various subsystems including, for example, an auxiliary power unit, cabin environmental controls, fuel system controls, anti-icing equipment, and security systems. The flight controller 109 may receive or otherwise access validated routes, and operate the onboard systems (e.g., propulsion, flight control surfaces, landing gear, flaps, air brakes, wheel brakes, etc.) to cause the aircraft 102 to traverse a validated route. Routes that are used by the flight controller 109 may include any suitable data and/or data structures that ultimately allow the flight controller 109 to cause the aircraft to traverse the trajectory defined by the validated route. For example, routes may include mathematical functions that define a path through three-dimensional space (the path for the aircraft to traverse); point sets that include a series of discrete target points that together define a path through three-dimensional space; a continuous path defined by a series of straight segments and curved segments (as defined by mathematical and/or geometric functions); speed setpoints along the path; acceleration setpoints along the path; and the like. More generally, the route may include any data, data structures, setpoints, parameters, or other information that a flight controller needs in order to cause the aircraft to traverse a trajectory defined by the route. Because a route defines or includes a trajectory (among other possible data or flight specifications), an aircraft may be said to traverse a trajectory or traverse a route. It will be understood that an aircraft traversing a route corresponds to an aircraft traversing a trajectory that is defined by the route. Moreover, a trajectory may define a path, through three-dimensional space, between any two locations (including between airports, between two locations in air, between a location on land and a location in the air, etc.). Thus, trajectories may refer to portions or segments of a full path that is traversed by an aircraft during a mission or a complete flight.

The aircraft 102 may include flight controls that allow an onboard pilot to manually fly the aircraft. For example, the aircraft 102 may include a yoke 105 (or other control system, such as a control stick) that controls one or more flight control surfaces of the aircraft, rudder pedals 106, throttle controls 108, as well as other controls that facilitate manual control of the aircraft.

The flight controller 109 may control the various systems of the aircraft either through motorized or adapted versions of human operated controls, through dedicated control mechanisms, or a combination of the two. In some cases, the aircraft 102 is equipped with redundant electro-mechanical systems for each control operation and may include various other systems to ensure safe and reliable operation of the aircraft. The flight controller 109 may also be operably coupled to various sensors including, without limitation, airspeed sensors, temperature sensors, altimeters, global positioning system (GPS) sensors, accelerometers, tilt sensors, radar sensors, LiDAR sensors, and cameras, which may provide feedback for closed-loop control operations for various aircraft functions and/or operations.

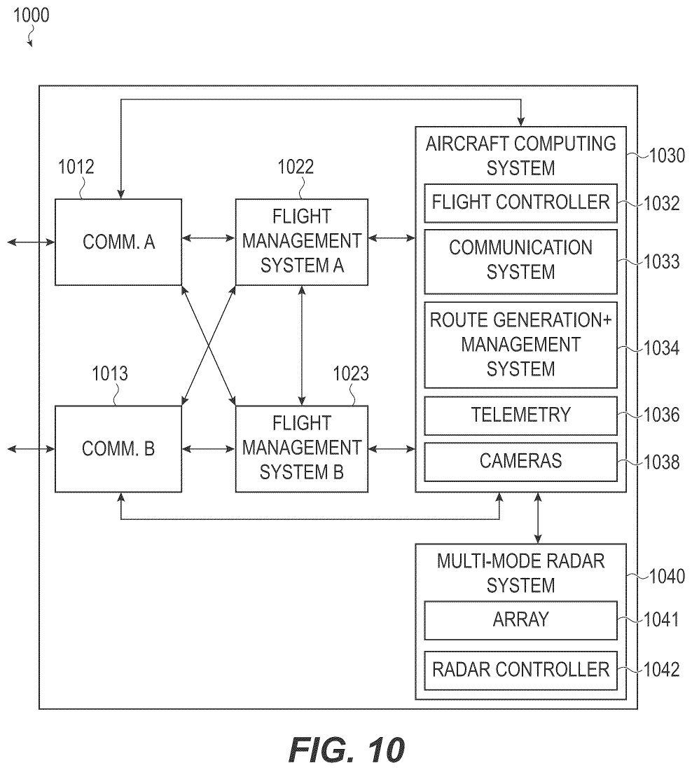

The flight controller 109 may be configured to control various systems of the aircraft 102 to cause the aircraft to traverse validated routes. In particular, the flight controller 109 may receive or access a validated route, and operate the aircraft systems to fly the aircraft along the validated route. The flight controller 109 may determine how to control the aircraft 102 in order to traverse the route, including determining throttle settings, flight control surface manipulations, flap settings, landing gear settings, brake settings, and any other aircraft functions. Thus, the route may indicate the trajectory to be flown (and may define the target position of the aircraft along the trajectory as a function of time), and the flight controller 109 may determine how to operate the aircraft 102 to traverse the route. In some cases, the flight controller 109 may operate the aircraft 102 in order to traverse a route that is active in a route generation and management system 111 (or another component or system of an aircraft computing system more generally, such as the aircraft computing system 1030). The flight controller 109 may also execute ground-based operations, such as taxiing, takeoff, landing, etc. The flight controller 109 may be implemented by one or more computer systems. In some cases, the flight controller 109 may be a standalone computing system that interfaces with other computing systems on an aircraft (e.g., the RGMS 111, the flight management systems 103, etc.). In some cases, the flight controller 109 may be integrated with or instantiated by other computing systems of the aircraft, such as the aircraft computing system 1030 (FIG. 10).

As described herein, the flight controller 109 may also operate the aircraft 102 in order to traverse modified routes, which may include traversing certain predefined maneuvers, such as a constant radius turn or a constant rate ascent/descent. In both cases, the flight controller 109 may control numerous aircraft systems to execute the maneuver, including responding to changing weather and wind conditions, accounting for turbulence, and the like. For example, because a validated route or validated route deviation may define the position of the aircraft with respect to time (rather than particular flight control surface manipulations), the flight controller 109 may be configured to control the aircraft's flight systems in order to traverse the validated routes. Thus, for example, in a constant radius turn, the flight controller 109 may adjust multiple aircraft systems to maintain the constant radius turn, including adjusting bank angle (e.g., to maintain a constant radius in changing wind conditions), adjusting a yaw rate, and the like.

The aircraft 102 may also include a route generation and management system (RGMS) 111. The RGMS 111 may generate, manage, and validate routes for the aircraft 102. The RGMS 111 may interface with the flight controller 109 and/or the flight management system 103 of the aircraft to provide validated routes and/or cause the aircraft 102 to traverse the validated routes. The RGMS 111 may also receive information from an inceptor 107 and interpret the information as a proposal to modify a route in a certain way. The RGMS 111 may validate the modified routes and cause the aircraft 102 to traverse the modified routes. The RGMS 111 may be replicated in a ground-based RGMS, which may provide redundancy to the onboard RGMS 111. The RGMS 111 may be implemented by one or more computer systems. In some cases, the RGMS 111 may be a standalone computing system that interfaces with other computing systems on an aircraft (e.g., the flight controller 109, the flight management systems 103, etc.). In some cases, the RGMS 111 may be integrated with or instantiated by other computing systems of the aircraft, such as the aircraft computing system 1030 (FIG. 10). As described herein, the RGMS 111 may also receive information from a multi-mode radar system 117 and generate and validate route modifications in order to avoid or otherwise account for objects that are detected by the multi-mode radar system 117.

The aircraft 102 may also include an inceptor 107 that receives user manipulations and, in response to the manipulations, provides signals to the RGMS 111 (or another RGMS or other computing system associated with the aircraft 102) that are indicative of proposed deviations from a primary route. The inceptor 107 may resemble a joystick or other manipulatable input member and may be movable between a neutral position (e.g., a centered position) and one or more deflected positions. The deflected positions may include deflections in various different directions and various different distances (e.g., fore/aft and left/right). As described herein, when a manipulation of the inceptor 107 is detected, parameters of the manipulation (e.g., a manipulation direction and manipulation distance) may be mapped to predetermined flight maneuvers that deviate from a validated primary route (or any other route the aircraft is currently traversing). For example, a manipulation in a left/right direction (also referred to herein as a lateral direction) may map to a flight maneuver that includes a turn away from the primary route (where the direction of the turn and turn radius are defined by the direction and distance of the manipulation). As another example, a manipulation in a fore/aft direction may map to a flight maneuver that includes an ascent or descent relative to the primary route (where climb direction and the rate of climb are defined by the direction and distance of the manipulation). The predetermined flight maneuvers that a given inceptor input may be mapped to may be used to compute modified routes that include the predetermined flight maneuvers.

The inceptor 107 may also include systems that provide tactile feedback to a user. For example, the inceptor 107 may produce tactile feedback at deflection positions that are associated with different route parameters. For example, tactile feedback may be provided at several lateral positions to indicate a radius of a proposed turn (e.g., a first tactile output may be felt at a first deflection position, which results in a proposed turn having a one mile radius; a second tactile output may be felt at a second deflection position, which results in a proposed turn having a 0.5 mile radius; etc.), and at several fore/aft positions to indicate a climb rate of a proposed ascent/descent. The tactile feedback systems may include physical detents, a haptic actuator, a friction brake, or any other suitable tactile output system.

The inceptor 107 may be operationally coupled to the RGMS 111, which may interpret the signals from the inceptor 107 as proposals for modified routes (e.g., including the predetermined flight maneuver to which an input maps) and validate the proposed modified routes. If validated, the RGMS 111 causes the aircraft 102 to traverse the modified route (e.g., by providing the modified route to the flight controller 109 of the aircraft). In some cases, inceptor inputs may be provided in response to an operator receiving information about an object from a multi-mode radar system. For example, a multi-mode radar system may alert an operator about a detected object (e.g., the position and optionally historical and/or predicted motion of the object). In some cases, the multi-mode radar system may alert an operator when a collision or other adverse encounter with an object is predicted. In response to the information or the alert, the operator may move the inceptor 107 to initiate a route modification to avoid the obstacle. In some cases, when the multi-mode radar system alerts an operator about an object or a possible adverse encounter with an object, the RGMS 111 responds differently to inceptor inputs than when no such alert is active. For example, when an alert (from a multi-mode radar system) regarding an object or possible adverse encounter is active and an inceptor input is received, the RGMS 111 may generate a route modification that avoids the object or adverse encounter. The route modification may be based at least in part on a parameter or property of the inceptor input, such as a direction and magnitude of the inceptor input, and may specifically account for the object or adverse encounter. For example, the RGMS 111 may generate a route that avoids the object or adverse encounter by deviating the route in a direction indicated by the inceptor input and by a distance margin that is based on the magnitude of the inceptor input. Thus, for example, a small inceptor input to the left may result in the modified route avoiding the object or adverse encounter by deviating to the left by a relatively small amount, whereas a larger inceptor input to the left may result in the modified route deviating to the left by a relatively larger amount. The modified route may also implement predetermined maneuvers to avoid the object or encounter, such as a series of turns having predetermined radii (or other geometric properties), scalable splines (e.g., a series of turns that avoids a location and returns the aircraft to a primary route, and whose distance or deviation magnitude is scalable in accordance with the magnitude of the inceptor input), predetermined altitude changes (e.g., altitude changes at a predetermined rate), and the like.

The aircraft 102 may also include a flight management system 103. The flight management system 103 may be designed to receive, store, and provide visualizations of flight plans. Flight plans may define aspects of a planned or upcoming flight, such as an origin location or airport, a destination location or airport, trip waypoints, altitude targets, and the like. In general, a flight plan as input to and stored in a flight management system 103 may not fully define a three-dimensional trajectory of the aircraft. Rather, validated routes may be generated based at least in part on a flight plan from a flight management system 103, as described herein. The validated routes may define the three-dimensional trajectory of the aircraft, and a flight controller may be configured to the validated route to determine how to control the aircraft's various flight control systems in order to traverse the route.

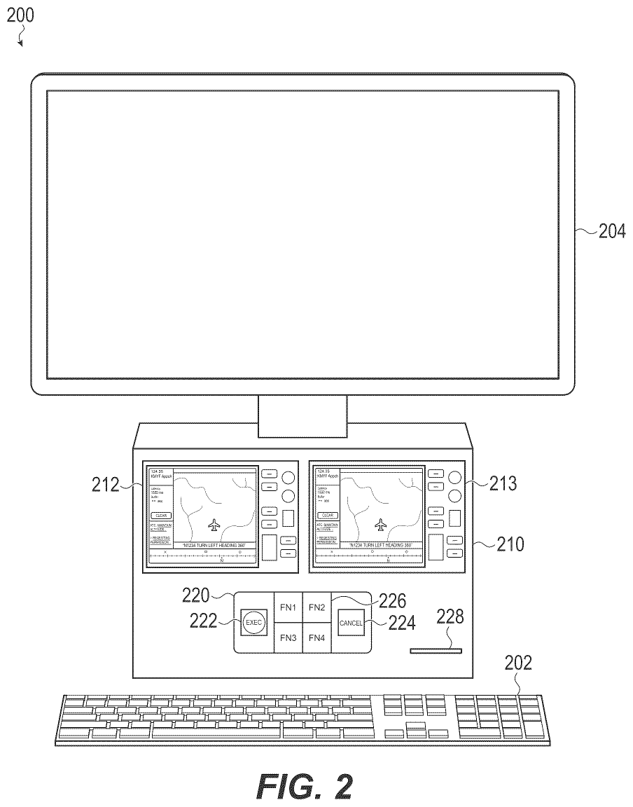

The flight management system 103 may be a redundant version of ground-based flight management systems (described with respect to FIG. 2, for example), and may provide the same general functionality as the ground-based flight management systems. The flight management system 103 may also include input and output systems (e.g., a display, buttons, a touch screen, etc.) to allow an operator to enter flight plans, view flight plans, modify flight plans, and the like.

As described herein, the RGMS 111 may generate and validate routes (e.g., primary and/or modified routes) and provide routes to the flight controller 109. The flight controller 109 may maintain only a single route as the active or current route at any given time. Accordingly, when the RGMS 111 modifies a route (e.g., in response to input from an inceptor), the RGMS 111 provides the modified validated route to the flight controller 109, which causes the aircraft to traverse the modified route in real time.

In some cases, a primary route may be received at the aircraft (e.g., at the RGMS 111, the flight controller 109, or an aircraft computing system more generally) from a ground station, as described herein. For example, a flight plan may be input into a flight management system that is located at a ground station. An RGMS, which may also be located at the ground station or otherwise communicatively coupled to the flight management system, may access the flight plan and develop a route that satisfies the flight plan. As described herein, the flight plan may specify certain aspects of a flight, such as the origin location (e.g., airport), destination location (e.g., airport), waypoints, and the like, but may not itself define a precise three-dimensional route or path for the aircraft. Accordingly, the RGMS may develop a route that satisfies all of the requirements of the flight plan and provides a precise specification of the proposed path or trajectory of the aircraft. The route may be the basis for a flight controller to execute a fully autonomous flight along the route. For example, the flight controller 109 may receive and/or access a route, and manipulate the various aircraft's systems (e.g., flight control surfaces, engines, landing gear, etc.) in order to cause the aircraft to traverse the route.

As noted, the route generated by an RGMS may define or specify the trajectory of an aircraft through multiple stages of its flight, including, for example, ground-based maneuvers, take-off maneuvers, flight maneuvers, landing maneuvers, etc. For turns during flight, the route may define or specify the location where a turn is initiated, the turn radius (which may be constant or variable), and the duration or distance of the turn. For changes in altitude, the route may define or specify the rate of change of altitude, the location where altitude changes are initiated and concluded, and the like. For ground-based maneuvers, the route may define or specify the precise route, along the ground, from a starting location to the takeoff point (including the taxiing route). As described herein, the RGMS or other suitable system may validate the route, which may include, for example, determining that the route is safe (according to one or more safety criteria), and that the aircraft is capable of executing the route (e.g., the route is fully within the aircraft's operational envelope).

Once a validated route is generated, it may be sent to the aircraft via one or more communications channels as described herein. (In some cases, a validated route may be generated onboard an aircraft, such as by an onboard RGMS generating a route based on a flight plan stored in an onboard flight management system.) The primary route may be received at an aircraft computing system onboard the aircraft, and may be loaded into a memory of the RGMS 111 on the aircraft. The aircraft may then autonomously traverse the primary route, such as by providing the primary route to the flight controller 109 or otherwise providing instructions to the flight controller 109 that allow it to autonomously operate the aircraft to traverse the primary route. While traversing the route, information from the multi-mode radar system 117 may be used to detect objects that may interfere with the aircraft's trajectory, and modify the route or otherwise cause the aircraft to take appropriate action (including, optionally, taking no action) in order to avoid the detected object.

In some cases, a modified flight plan may be input into a flight management system (and/or a flight plan that is currently stored and/or active in a flight management system may be modified). In such cases, the RGMS may access the modified flight plan (optionally during an ongoing autonomous flight that is traversing a primary route) and generate a new validated route for the aircraft to follow. In such cases, the new validated route may overlap the primary route (e.g., a terminal portion of the primary route may overlap an initial portion of the new route) such that the aircraft can begin to traverse the new route without disruption in aircraft operations.

The aircraft 102 may also be equipped with a multi-mode radar system 117, which may include an array of antenna elements, and associated radio and other circuitry to facilitate radar operations. For example, the array of antenna elements and associated circuitry may be configured to generate and emit RF signals, receive reflected RF signals, filter received signals, analyze received signals to determine position (and/or other) information of objects, weather, or other events or phenomenon, and the like. The multi-mode radar system 117 may be communicatively coupled to other systems and components of the aircraft 102 and/or aircraft operation system 100, such as the RGMS 111, the flight controller 109, the flight management systems 103, and the like. As described herein, information from the multi-mode radar system 117 may be used to modify a route or trajectory of an aircraft.

The multi-mode radar system 117 may operate the array of antenna elements in various ways to achieve various operational modes, as described herein. The particular mode that is used may depend on the current operation of the aircraft or phase of a mission. For example, a first mode of operation (e.g., a MIMO mode) may be used during ground-based operations, and a second mode of operation (e.g., pulsed mode) may be used during airborne operations. In some cases, during transition phases (e.g., takeoff and landing), the multi-mode radar system 117 alternates between modes (e.g., between MIMO and pulsed modes).

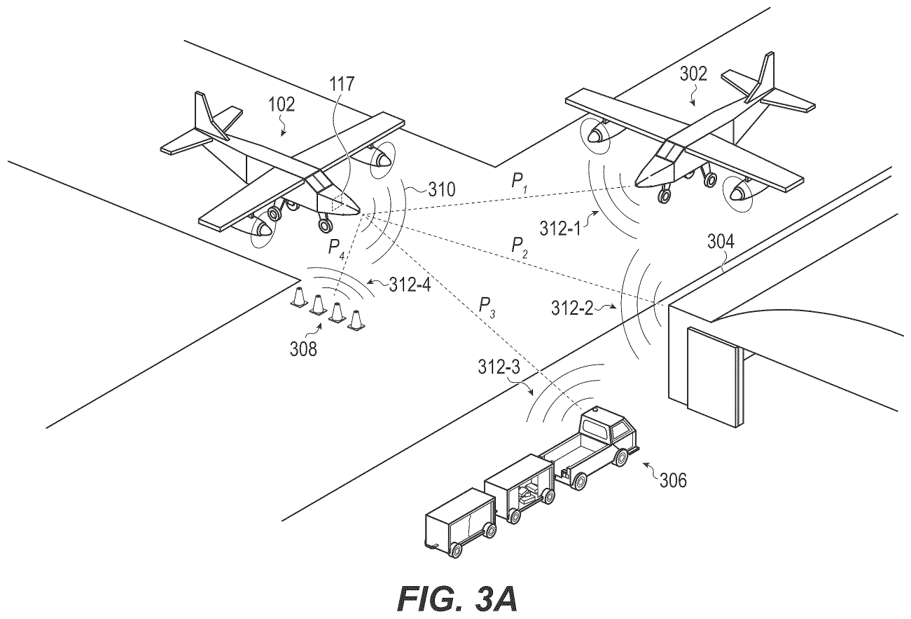

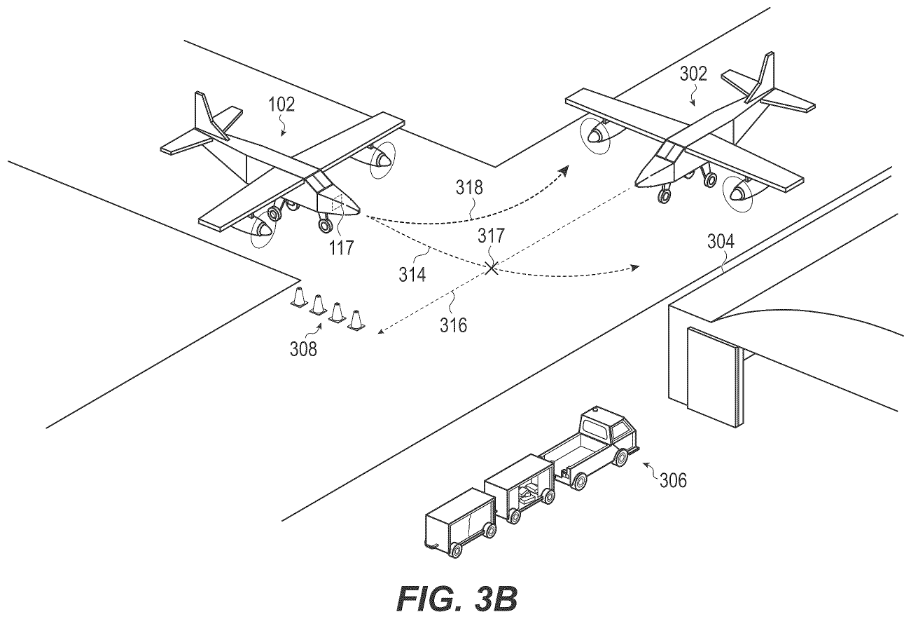

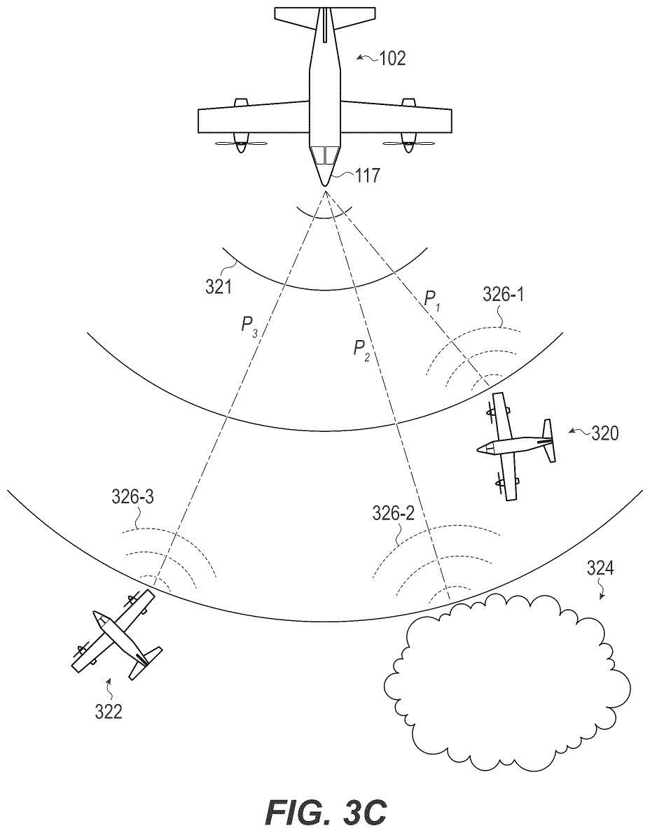

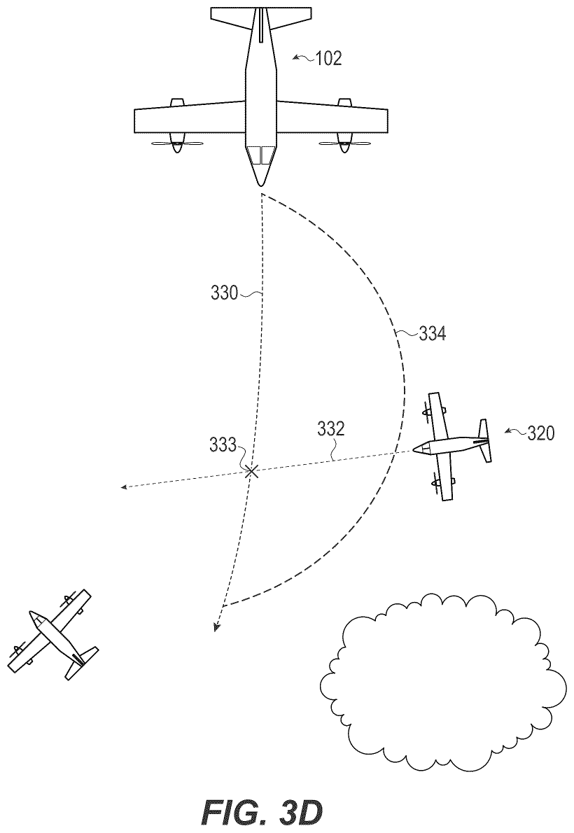

Additional description of the operation of the multi-mode radar system 117 is provided herein with respect to FIGS. 3A-7F.

The aircraft operation system 100 may include various computing systems and associated applications that facilitate autonomous flight operations. The aircraft operation system 100 may include computing systems such as the flight management controllers (both aircraft- and ground-based), route generation and management systems (both aircraft- and ground-based), multi-mode radar systems, and/or other computing systems. In some cases, operations are shared among multiple computing systems. In some cases, the computing systems may include redundancies. For example, the flight management system 103 and the flight management systems 212, 213 (FIG. 2) at a ground station 110 may each be configured to perform the same operations, and may share data, results, operational states, or other information between them in order to provide the functions and/or operations of the flight management systems. Similarly, the RGMS 111 and a ground-based RGMS may each be configured to perform the same operations, and may share data, results, operational states, or other information between them in order to provide the functions and/or operations of the RGMS.

Returning to FIG. 1, the communication network 120 and the described operation of the communication network 120 may provide several advantages including the ability to operate the aircraft 102 over a potentially large geographical area and utilize network elements that are accessible from a variety of locations. As shown in FIG. 1, the communication network 120 includes internet-service provider interfaces 122, 123, which are operably coupled to or integrated with the ground station 110. The communication network 120 also includes one or more communication routing elements 124, 125, which may include systems and hardware that are accessible over a public network like the Internet. The communication network 120 also includes one or more satellite sub-systems 126, 127, which are adapted to relay communications from ground-based elements to one or more communication interfaces 128, 129 onboard the aircraft 102.

The communication network 120 may leverage existing network hardware elements and also enable the ground station 110 to be operated from a variety of locations and in a variety of conditions. The communication network 120 may also provide more consistent and reliable communication links that are relatively unaffected by geographic topology, weather, and other factors that may interfere with some traditional communication schemes. The communication network 120 alone or in combination with the security system 130 may provide reliability that meets or exceeds regulatory requirements specified by the Federal Aviation Administration (FAA) or other regulatory authority. The described systems and techniques may also help to ensure the safe and robust operation of the aircraft 102 even while the operation of individual network elements may falter or become unreliable.

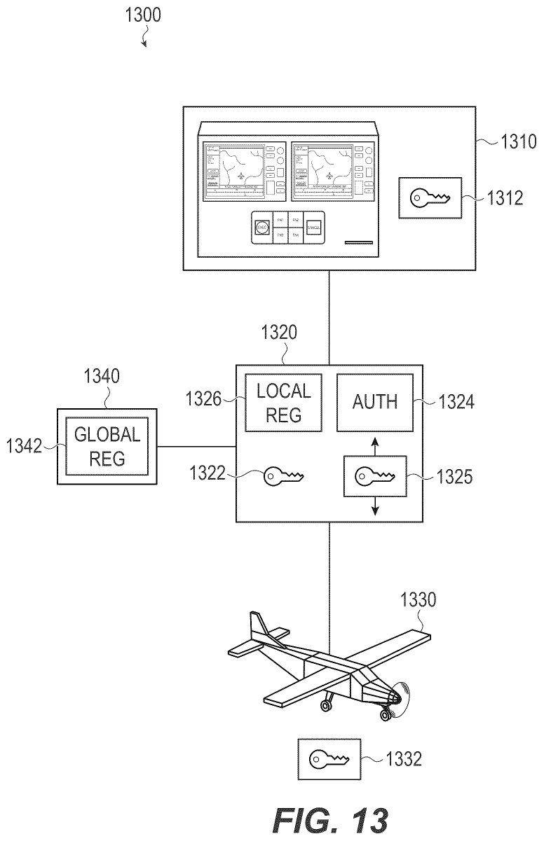

Described in more detail below with respect to FIG. 13, the security system 130 may include a cloud-based registry 134, which may be used to maintain a list of authenticated users (authorized pilots) and registered components (e.g., ground stations and aircraft), which may be referenced by the routing elements 124, 125 during operations. The security system 130 may be maintained and/or adapted by a security administrator 132. The security administrator 132 may be a separate device or, in some implementations, be integrated with the ground station 110.

Each of the subsystems operated on board the aircraft 102 may be relayed to the ground station 110 by the communication network 120. In the present example, the aircraft 102 relays signals to the ground station 110 via satellite subsystems 126, 127 and network routing elements 124, 125 that may conduct communications using a digital or network communication scheme. Specifically, data may be transmitted from the aircraft 102 to the satellite subsystems 126, 127 via an uplink channel, which may transmit uplink data packets. Similarly, data may be received from the satellite subsystems 126, 127 via a downlink channel, which may transmit downlink data packets. The uplink channel and downlink channel may be operated by one or more interfaces 128, 129, which may include one or more onboard transceivers configured to conduct wireless communications with the satellite using an established procedure and frequency band. In some cases, the uplink channel and downlink channel are operated over a common or shared network layer, data link layer, and/or physical communication layer. The transceiver(s) of the interfaces 128, 129 may be adapted to conduct Ka-band communications (26-40 GHz), Ku-band communications (12-18 GHz), X-band communications (8-12 GHz), C-band communications (4-8 G Hz), S-band communications (2-4 GHZ), L-band communications (1-2 GHz), or other established communication bands.

Similarly, other elements of the communication network 120 and the ground station 110 may conduct communications with the satellite subsystems 126, 127 through uplink and downlink channels, which may transmit data packets or other digital communications. Similar to the aircraft-side of the satellite communication scheme, the uplink channel and downlink channel may operate over a shared network layer, data link layer, and/or physical communication layer. Other elements of the communication network 120 including the routing elements 124, 125 may be coupled to the satellite subsystems 126, 127 via a satellite service provider that is operably coupled to the other elements of the communication network 120 over a computer network like the Internet. For purposes of the current examples and explanation, the satellite subsystems 126, 127 may include a terrestrial transmission station, which may be operated by a third party.

The data communication packets of the communication system 120 may be generated in accordance with an established communications protocol. For example, the data communication packets may be generated in accordance with a Real-time Transport Protocol (RTP), which may include Real Time Communications (RTC) such as WebRTC protocols enabled through a web browser, Real-Time Messaging Protocols (RTMP), Real-Time Streaming Protocols (RTSP), and other similar protocols. Other protocols may include HTTP live streaming (HLS) protocols like Low Latency HLS or other similar streaming communication schemes. These and other protocols may also be broadly characterized as Voice Over Internet Protocol (VOIP) in which analog voice communications are converted to digital data objects and transported via an Internet Protocol (IP) communication system. While framed or packeted communication schemes may be used, it is not necessary to use either framed or IP communication schemes for the data communication packets of the communication network 120.

As described herein, the system 100 may utilize the same uplink/downlink communication channels for transmitting flight control information, sensor readings, images, video feeds, or perform other data exchanges between the ground station 110 and the aircraft 102. In some cases, some or all of these data exchanges are performed on a separate communication channel that is routed through the communication network 120. If the aircraft 102 is predicted to be in reliable communication using another wireless communication network, some or all of the above-referenced data exchanges or voice communications may be, at least temporarily, conducted through another non-satellite wireless communication network.

As described herein, the communication network 120 may utilize redundant system elements, which may be used in parallel data packet transmission operations as well as fail-over alternative paths when one or more network elements become inoperable or unreliable. Specifically, the proposed system includes redundant internet provider interfaces 122, 123, which may be operated by distinct or separate providers. In some cases, one of the interfaces 122 is provided via a wired communication channel and the other interface 123 is provided via a wireless channel (e.g., 4G and/or 5G wireless communications). Each of the interfaces 122, 123 may be operably coupled to each of the routing elements 124, 125 creating a redundant and alternative path for communication packets to and from the ground station 110. Similarly, each of the routing elements 124, 125 may be operably coupled to one or more satellite subsystems 126, 127. While two satellite subsystems 126, 127 are depicted in the system 100 of FIG. 1, the satellite subsystems 126, 127 may be integrated or shared, depending on the implementation.

FIG. 2 depicts an example ground station for generating and communicating flight plans and routes for an aircraft. Specifically, FIG. 2 depicts an example ground station 200 that may correspond to the ground station 110 of FIG. 1. In general, the ground station 200 is configured to provide redundant flight management operations with an affirmative set of designated controls and a system for authenticating a remote pilot. The design of the ground station 200 provides important redundancy and confirmation that flight plans, routes, and other ground station instructions are accurate, authenticated, and intentionally executed. Moreover, in some cases, the ground station 200 receives requests for deviations from validated primary routes, validates those requests, and, if validated, provides modified routes to an aircraft for execution by the aircraft.

As shown in FIG. 2, the ground station 200 includes two ground-based flight management systems 212, 213 which may be operated in tandem. In particular, instructions or input provided to one of the ground-based flight management systems 212, 213 may be replicated to the other system allowing for parallel and redundant operations (and may also be replicated to the flight management system 103 onboard the aircraft 102). The flight management systems 212, 213 may be designed to receive full or partial flight plans directly via user input or via another flight plan input operation (e.g., uploading a flight plan). The flight management systems 212, 213 are operably coupled to a ground-based RGMS, which can be used to access flight plans, and generate and validate routes based on flight plans, and coordinate operations with other elements of the system. In some cases, the flight management system 212, 213 may operate as input devices for the RGMS. For example, flight plans may be input via a flight management system, and then the RGMS may access the flight plans and generate validated routes based on (and satisfying) the flight plans.

As shown in FIG. 2, the ground station 200 also includes an interface panel 220 that provides a set of designated control elements 222, 226, 224, which may be linked to specific system operations. In some cases, the designated control elements 222, 226, 224 can be customized by the user and in some cases, the designated control elements 222, 226, 224 have a dedicated function that cannot be changed or configured by the user. In the present example, the designated control elements 222, 226, 224 are hardware buttons that operate electromechanical switches. However, in other implementations, some or all of the buttons may be implemented via a programmable interface like a touchscreen display or configurable touch panel. In the present example, the control element 222 is operable to confirm execution of flight controls or a validated route. The control element 224 may be operable to cancel a flight control or a validated route. The other control elements 226 may be configured to handle a variety of designated functions including, for example, abort operations, dedicated flight commands (e.g., land now or land soon), or other predefined operations (e.g., vector or abort).

The ground station 200 of FIG. 2 also includes a port 228 for receiving electronic credentials from an operator of the ground station 200. In some implementations, the port 228 is configured to receive a smart card or other similar device that is adapted to authenticate the user. By way of example, the port 228 may be configured to electronically receive an authentication token or signature that is associated with a user authorized to operate the ground station 200. Specifically, the ground station 200 may be able to identify and authenticate a pilot that has been approved to create and execute flight instructions for an aircraft. The token or signature may be a Public Key Infrastructure (PKI) used to store a digital certificate, which may be used to identify the user. In some cases, the PKI may also be used to digitally sign communications or instructions and/or used for encrypting data packets transmitted using the system described herein.

The ground station 200 may also be used to monitor and control various aspects of the aircraft. As shown in FIG. 2, ground station 200 includes a monitor or display 204, which can be used to display proposed flight plans, routes, or aircraft commands for review and confirmation of the user. The display 204 may be operably coupled to an RGMS and used to perform various operations of the RGMS and other aspects of the system.

In some cases, the ground station 200 may display various navigational information including, without limitation, GPS location information, airspeed and heading information, radar information, or other data regarding a current status of the aircraft, as detected by one or more onboard sensors or devices. In some cases, the ground station 200 may display a video feed or image displaying video or images captured by an onboard camera. The ground station 200 may also display a virtual instrumentation panel that simulates a portion of the instrumentation panel on the aircraft, which may include distinct regions for each instrument including a graphical output that is varied in accordance with instrumentation or sensor readings obtained by the aircraft. The instrumentation panel may be displayed using the display 204 or may be displayed using an auxiliary display or device.

The ground station 200 may also provide one or more controls for operating an onboard radio or controlling other communications between the aircraft and another aircraft, air traffic control (ATC), or another entity. For example, using the virtual or hardware-based control elements, the remote pilot or other operator can select frequency bands and/or power levels used by the aircraft for communication with ATC, select one or more predetermined radio settings for operating the audio hub of the aircraft, reset the audio hub, or provide other remote commands, which are communicated through the communication system to the aircraft. The ground station 200 may also include audio elements like a microphone and speaker used to facilitate the creation and monitoring of audio communications with the aircraft or other entities.

As shown in FIG. 2, the ground station 200 may also include various input devices 202, which may include keyboards, mice, trackpads, tablets, joysticks, scroll wheels, and other input devices. Additionally, in some implementations, the ground station 200 may include multiple auxiliary displays or auxiliary devices, like tablets or notebook computers, which may be used to monitor or control other aspects of the system.

As described herein, an aircraft may use a multi-mode radar system to detect the presence and positional information of objects outside of the aircraft. The multi-mode radar system may be operated in different radar modes during different aircraft operations and/or phases of a flight operation. FIG. 3A illustrates an example aircraft 102 during a ground transit phase of an autonomous flight, such as a taxiing operation (e.g., taxiing for takeoff or taxiing from landing). The aircraft 102 includes the multi-mode radar system 117, which includes an array (e.g., a two-dimensional array) of antenna elements that are configured to transmit and/or receive radio frequency signals. The array may be operatively coupled to a controller and other components and/or circuitry that operate the array to emit and receive radio frequency signals, and determine positional information of objects. The multi-mode radar system 117 is shown in a nose of the aircraft 102 in this example, though this is not limiting, and the multi-mode radar system 117 may be positioned elsewhere on the aircraft 102. In some cases, multiple multi-mode radar systems and/or arrays are employed on a single aircraft.

As described herein, ground-based operations and maneuvers, such as taxiing, may benefit from the ability to detect nearby objects and their position with high-spatial resolution, and with minimal lag or latency. In particular, due to the relatively close proximity of objects and obstacles during ground transit, as well as the possibility that they will move without advance notice, operating the radar in a mode that is tailored to fast, close-range detection may provide a high degree of environmental awareness. For example, during a ground-based transit operation (e.g., taxiing), the multi-mode radar system may be operated in a MIMO radar mode. In the MIMO mode, multiple subsets of the antenna elements of the array of the multi-mode radar system 117 may be operated in a transmit mode (e.g., continuously transmitting radio frequency waveforms or signals), while multiple subsets of the antenna elements of the array may be operated in a receive mode (e.g., continuously receiving reflected radio frequency waveforms or signals). In the MIMO mode, the multi-mode radar system may use orthogonal frequency-divisional multiplexing techniques to facilitate the MIMO functionality. In such cases, the antenna elements operating in the receive mode may use matched filters to distinguish between the signals received from the different transmitters. In some cases, the antenna elements operating in the transmit mode may emit coded waveforms whose reflections can be distinguished by the radar system. More generally, the radar system may use time, frequency, or coding techniques to allow the signals from the different transmitting elements to be differentiated (e.g., to allow the radar system to identify the particular antenna element that a reflected signal originated from).

FIG. 3A illustrates an example aircraft 102 during a ground transit phase of an autonomous flight, such as a taxiing operation. As shown, the radar system 117 (e.g., the two-dimensional array of antenna elements) is emitting RF signals 310. The RF signals 310 may include at least two RF signals, which may be different waveforms (e.g., a first waveform and a second waveform that is different from the first). Each respective RF signal may be emitted by a respective subset of the antenna elements of the array, and they may be emitted continuously.

The RF signals 310 propagate through the air and reflect off of objects that they encounter. In the example of FIG. 3A, the RF signals 310 may be reflected by a second aircraft 302 (reflected signals 312-1), a building 304 (reflected signals 312-2), a vehicle 306 (reflected signals 312-3), and barriers 308 (reflected signals 312-4). The multi-mode radar system 117 detects the reflected signals at the subsets of the antenna elements that are operating in the receive mode. The multi-mode radar system 117 determines position information of the objects based on the received reflected signals. For example, the multi-mode radar system 117 may be operating in a MIMO mode, such that the multi-mode radar system 117 acts as a phased array radar to identify, with a high degree of positional accuracy, position information for objects within the radar's range.

The multi-mode radar system 117 may determine position information for the objects from which reflected signals are received. Position information may define the position of the object relative to the array, and may be represented in any suitable manner and using any suitable coordinate system. For example, the position information may include or define a distance to the object (e.g., a straight-line distance) and a direction to the object. The direction to the object may be represented by an azimuth angle and an elevation angle (relative to the plane defined by the array), or any other suitable values or notation. As shown in FIG. 3A, the multi-mode radar system may determine position information P1 of the aircraft 302, position information P2 of the building 304, position information P3 of the vehicle 306, and position information P4 of the barriers 308.

The multi-mode radar system 117 may also record the positions of objects over time (e.g., over multiple time intervals or radar scan cycles), and may predict, based on the historical position records, future positions, movements, or trajectories of the objects. For example, in the case of FIG. 3A, the multi-mode radar system 117 may record position information over time for the aircraft 302 and determine the trajectory of the aircraft 302 over that time (e.g., traversing in a straight line at a certain speed). Based on the historical trajectory, the multi-mode radar system 117 may predict that it may continue on that trajectory, and may determine the predicted position of the aircraft 302 at future times (e.g., based on a predicted future trajectory). In some cases, the prediction may include a confidence indicator representing a confidence that a moving object (e.g., the aircraft 302) will arrive at a given position on its predicted trajectory. For example, the confidence indicator may reflect a higher confidence that the aircraft 302 will continue on its predicted trajectory for the immediate future, but may reflect a lower confidence that the aircraft 302 will maintain its speed and direction further into the future. As another example, if an object does not move or change position (e.g., over a certain time window), the confidence indicator may reflect a higher confidence that the object will remain stationary for the immediate future, but reflect a lower confidence that the object will remain stationary further into the future.

In some cases, the multi-mode radar system 117 may attempt to classify detected objects based on their radar signature, and may predict their future positions, movements, or other actions based at least in part on the classification. For example, the multi-mode radar system 117 may predict, based on a radar signature, that the object 302 is an aircraft, the object 304 is a building, the object 306 is a vehicle, and the object 308 is a road barricade. This prediction may be performed by comparing the radar signature of the objects to a set of reference radar signatures (e.g., radar signatures of known objects or classes of objects) to determine a similarity between the detected signatures and the reference signatures. Other techniques for predicting a type of object based on its radar signature, which may include, for example, doppler techniques, may also be employed.

Each reference object or type of reference object may be associated with a set of possible trajectories, movements, or maneuvers that it may be capable of or likely to perform. For example, buildings will be associated with no movement, while aircraft may be associated with certain types of movements or trajectories, and road-going vehicles with other types of movements or trajectories. The predicted or possible trajectories of given objects may also be based in part on known terrain and/or geographic features. For example, vehicles may be associated with a higher likelihood of traversing roads (e.g., as compared to taxiways and runways), while aircraft may be associated with a higher likelihood of traversing taxiways and runways (e.g., as compared to roads). The predicted or possible trajectories of given objects may also be based in part on the types of maneuvers or operations that the objects are capable of. For example, aircraft may be associated with a lower likelihood of reversing than road vehicles, humans may be associated with a lower top speed than vehicles and more variable movements (e.g., vehicles typically cannot change direction as rapidly or in as many possible directions as a person).

Thus, the multi-mode radar system 117 and/or other system of the aircraft 102 (e.g., the RGMS 111) may predict future trajectories of detected objects based at least in part on the type of the object (e.g., aircraft, building, vehicle, person, etc.), terrain and/or geographic features (e.g., the positions of roads, taxiways, aprons, runways, parking lots, etc.), the likelihood of such objects traversing the known terrain or geographic features, and the types of maneuvers, movements, or operations that such objects are capable of.

As described herein, the aircraft 102 may be configured for autonomous flight, in which the aircraft autonomously traverses a predefined validated route. As noted, the validated route defines a trajectory that is free of known obstacles or obstructions. However, real world conditions may vary, and unforeseen objects may ultimately interfere with the aircraft's trajectory. Accordingly, the aircraft 102 may use position information of objects, as detected by the multi-mode radar system 117 (and optionally predicted trajectory or future motion information, as described above), to verify that its route is indeed safe (e.g., free of collisions or predicted collisions or other interferences), and may take corrective action as necessary. Corrective action may include, without limitation, generating a route modification (e.g., changing a speed, direction of travel, altitude, etc.), temporarily stopping, aborting a route or mission, or the like.

FIG. 3B illustrates an example scenario of the aircraft 102 using position information of a ground-based object (as determined by the multi-mode radar system 117) to change its route. The aircraft 102 may be executing an autonomous ground-based traversal, such as an autonomous taxiing phase. For example, the aircraft 102 may be traversing a ground portion of a validated route that defines a predefined trajectory 314 over the ground. While traversing the predefined trajectory 314 (or prior to starting the traversal), the aircraft 102 may detect a position of the aircraft 302. In some cases, the aircraft 102 may predict a future position of the aircraft 302. For example, the aircraft 102 may predict a trajectory 316 of the aircraft 302 based on position information of the aircraft 302 detected at different times by the multi-mode radar system 117, as described herein. The aircraft 102 may then predict whether a collision is likely between itself and the aircraft 302, based on the position of the aircraft 302 or a predicted future position of the aircraft 302 (e.g., as defined by its predicted trajectory 316). More particularly, the aircraft 102 may determine whether its predefined trajectory 314 intersects the detected position of the aircraft 302 or a predicted position of the aircraft 302 at a future time. As shown in the example in FIG. 3B, the aircraft 102 determines that its predefined trajectory 314 intersects a predicted position of the aircraft 302 at point 317 (e.g., the aircraft 102 and the aircraft 302 would collide at point 317 if they maintained their predefined trajectory and predicted trajectory, respectively).

In response to the prediction of the collision between the aircraft 302 and the aircraft 102 (e.g., at point 317), the aircraft 102 may execute a ground maneuver to change a direction of travel of the aircraft over the ground. For example, the aircraft 102 may traverse an alternate trajectory 318, which will route the aircraft 102 behind the aircraft 302 to avoid a possible collision. In another example, the aircraft 102 may stop moving or slow its movement along the trajectory 314 in order to avoid the collision.

Predicted trajectories of objects based on the position data from a multi-mode radar system 117 may be generated by the multi-mode radar system 117 or another system of the aircraft 102, such as a route generation and management system (e.g., the RGMS 111). The RMGS 111 (or other system of the aircraft 102) may use the position and trajectory information to detect a potential adverse encounter with another object. If a potential adverse encounter is predicted, the RGMS 111 may produce a validated modified route that avoids or mitigates the adverse encounter. For example, the RGMS 111 may accept, as input, information from the multi-mode radar system 117, such as position data of objects in the radar's range, determine a predicted trajectory for the objects, determine whether an adverse encounter is predicted, and then produce a validated modified route that avoids or mitigates the adverse encounter. In some cases, the validated modified route is produced using the same or similar validation criteria as other validated routes. For example, while a validated route may be preconfigured to avoid known obstacles such as mountains and known buildings, the RGMS may consider the location of the predicted adverse encounter similar to a known obstacle, and produce a trajectory that avoids that location.

In some cases, a predicted location of an adverse encounter may encompass a certain area to account for possible deviations from the predicted events. For example, while the aircraft 102 may predict that the aircraft 302 will continue along the trajectory 316, it is possible that a pilot of the aircraft 302 will anticipate the issue and change its trajectory. In order to account for such conditions, the RGMS 111 may identify an area of a potential adverse encounter, and produce a modified validated route that avoids the area entirely. The area in which a potential adverse encounter is detected and that the RGMS 111 avoids when generating a modified route may be referred to as an avoidance area. The avoidance area may include the actual location of the object, and an area around the actual location that represents possible future positions of the object for a certain time window. The avoidance area may be determined based at least in part on characteristics of the object (e.g., if the object has been classified as corresponding to a certain type of object). The avoidance area may be determined based at least in part on the speed of the object, the object's direction of travel, the maneuverability of the object, and the like (e.g., including any characteristics of the object that may affect how it may behave in the future). Thus, for example, the avoidance area around a person may be smaller than an avoidance area around a vehicle (for a given time window), due to the relatively higher possible speeds of a vehicle.

FIG. 3C illustrates an example aircraft 102 during a flight phase of an autonomous flight. As described herein, the multi-mode radar system 117 may be operated in a different radar mode during autonomous airborne operations than it is during autonomous ground-transit operations. For example, the multi-mode radar system 117 may be operated in a pulsed radar mode, which may have a greater range than the MIMO mode (or other mode used during ground operations). As described herein, operating in the pulsed radar mode may include operating the two-dimensional array of antenna elements of the multi-mode radar system 117 in a transmit mode for a first duration (e.g., to emit an RF signal 321), and after the first duration, operating the array of antenna elements in the receive mode for a second duration. The RF signals 321 propagate through the air and reflect off of objects that they encounter. In the example of FIG. 3C, the RF signals 321 may be reflected by an aircraft 320 (reflected signals 326-1), a weather event 324 (reflected signals 326-2), and an aircraft 322 (reflected signals 326-3). The multi-mode radar system 117 detects the reflected signals at the antenna elements that are operating in the receive mode during the second duration. The multi-mode radar system 117 determines position information of the objects based on the received reflected signals.

FIG. 3C illustrates the multi-mode radar system 117 receiving reflected signals 326-2 from a weather event. In some cases, the multi-mode radar system 117 may receive the reflected signals from weather events and airborne objects (e.g., aircraft), and provide information about both (e.g., position information of the airborne objects and position and meteorological information about the weather events). In such cases, the multi-mode radar system 117 may be configured to emit pulses having different characteristics (e.g., different frequencies) in order to detect both airborne objects and weather events (or other atmospheric phenomena). The multi-mode radar system 117 may include multiple arrays of antenna elements to facilitate the transmission and reception of the different types of RF signals.

In some cases, the multi-mode radar system 117 is not configured to detect weather events (e.g., precipitation, moisture, clouds, etc.). For example, the multi-mode radar system 117 may emit RF signals 321 that are not well adapted to reflection from weather events, and/or the multi-mode radar system 117 may not be configured to interpret signals reflected from weather events.

The multi-mode radar system 117 may determine position information for the objects from which reflected signals are received. Position information may define the position of the object relative to the array, and may be represented in any suitable manner and using any coordinate system. For example, the position information may include or define a distance to the object (e.g., a straight-line distance) and a direction to the object. The direction to the object may be represented by an azimuth angle and an elevation angle (relative to the plane defined by the array), or any other suitable values or notation. As shown in FIG. 3C, the multi-mode radar system may determine position information P1 of the aircraft 320, position information P2 of the weather event 324, and position information P3 of the aircraft 322.

The multi-mode radar system 117 may also record the positions of objects over time (e.g., over multiple time intervals or radar scan cycles), and may predict, based on the historical position records, future positions, movements, or trajectories of the objects. For example, in the case of FIG. 3C, the multi-mode radar system 117 may record position information over time for the aircrafts 320 and 322 and determine their trajectories over that time. Based on the historical trajectory, the multi-mode radar system 117 may predict future trajectories (along with confidence indicators) for the aircrafts. Example techniques for recording and predicting trajectories are discussed above with respect to FIGS. 3A-3B, and that discussion applies equally to FIGS. 3C-3D.

In some cases, the multi-mode radar system 117 may attempt to classify detected objects based on their radar signature, and may predict their future positions, movements, or other actions based at least in part on the classification. For example, the multi-mode radar system 117 may predict, based on a radar signature, what type of aircraft the aircraft 320, 322 are, which in turn allows the multi-mode radar system 117 (or another system of the aircraft 102) to predict future trajectories of the aircraft (as described with respect to FIGS. 3A-3B).

As described herein, the aircraft 102 may be configured for autonomous flight, in which the aircraft autonomously traverses a predefined validated route. As noted, the validated route defines a trajectory that is free of known obstacles or obstructions. However, real world conditions may vary, and unforeseen objects may ultimately interfere with the aircraft's trajectory. Accordingly, the aircraft 102 may use position information of objects, as detected by the multi-mode radar system 117 (and optionally predicted trajectory or future motion information, as described above), to verify that its route is indeed safe (e.g., free of collisions or predicted collisions or other interferences), and may take corrective action as necessary. Corrective action may include, without limitation, generating a route modification (e.g., changing a speed, direction of travel, altitude, etc.), temporarily stopping, aborting a route or mission, or the like.

FIG. 3D illustrates an example scenario of the aircraft 102 using position information of an airborne object (as determined by the multi-mode radar system 117) to change its route. The aircraft 102 may be operating in an autonomous flight phase. For example, the aircraft 102 may be traversing an airborne portion of a validated route that defines a predefined trajectory 330 through the air. While traversing the predefined trajectory 330, the aircraft 102 may detect a position of the aircraft 320, and may predict a future position of the aircraft 320. For example, the aircraft 102 may predict a trajectory 332 of the aircraft 320 based on position information of the aircraft 320 detected (e.g., over multiple radar cycles or pulses) by the multi-mode radar system 117, as described herein. The aircraft 102 may then predict whether a collision is likely between itself and the aircraft 320, based on the position of the aircraft 320 or a predicted future position of the aircraft 320 (e.g., as defined by its predicted trajectory 332). More particularly, the aircraft 102 may determine whether its predefined trajectory 330 (corresponding to its validated route) intersects the predicted position of the aircraft 322 at a future time. As shown in the example in FIG. 3D, the aircraft 102 determines that its predefined trajectory 330 intersects a predicted position of the aircraft 320 at point 333 (e.g., the aircraft 102 and the aircraft 322 would collide at point 333 if they maintained their predefined trajectory and predicted trajectory, respectively).

In response to the prediction of the collision between the aircraft 302 and the aircraft 102 (e.g., at point 317), the aircraft 102 may execute a flight maneuver to change a direction of flight of the aircraft. For example, the aircraft 102 may traverse an alternate trajectory 334, which will route the aircraft 102 behind the aircraft 322 to avoid a possible collision. In another example, the aircraft 102 may reduce or increase its airspeed, or change its altitude to avoid the collision.

Predicted trajectories of airborne objects based on the position data from a multi-mode radar system 117 may be generated by the multi-mode radar system 117 or another system of the aircraft 102, such as a route generation and management system (e.g., the RGMS 111). The RMGS 111 (or other system of the aircraft 102) may use the position and trajectory information to detect a potential adverse encounter with another object. If a potential adverse encounter is predicted, the RGMS 111 may produce a validated modified route that avoids or mitigates the adverse encounter. For example, the RGMS 111 may accept, as input, information from the multi-mode radar system 117, such as position data of objects in the radar's range, determine a predicted trajectory for the objects, determine whether an adverse encounter is predicted, and then produce a validated modified route that avoids or mitigates the adverse encounter. In some cases, the validated modified route is produced using the same or similar validation criteria as other validated routes. For example, while a validated route may be preconfigured to avoid known obstacles such as mountains and known buildings, the RGMS may consider the location of the predicted adverse encounter similar to a known obstacle, and produce a trajectory that avoids that location.

In some cases, a predicted location of an adverse encounter in the air may encompass a certain area to account for possible deviations from the predicted events. For example, while the aircraft 102 may predict that the aircraft 320 will continue along the trajectory 332, it is possible that a pilot of the aircraft 320 will change its trajectory. In order to account for such conditions, the RGMS 111 may identify an area of a potential adverse encounter, and produce a modified validated route that avoids the area entirely. The area in which a potential adverse encounter is detected and that the RGMS 111 avoids when generating a modified route may be referred to as an avoidance area. The avoidance area may include the actual location of the object, and an area around the actual location that represents possible future positions of the object for a certain time window. The avoidance area may be determined based at least in part on the speed of the object, the object's direction of travel, the maneuverability of the object, and the like (e.g., including any characteristics of the object that may affect how it may behave in the future). In some cases, the avoidance area for airborne encounters is greater than the avoidance area for ground-based encounters. This may account for various differences in ground-based and airborne operations, such as the higher speeds, lower maneuverability, and greater available maneuvering space in the air as compared to on the ground.

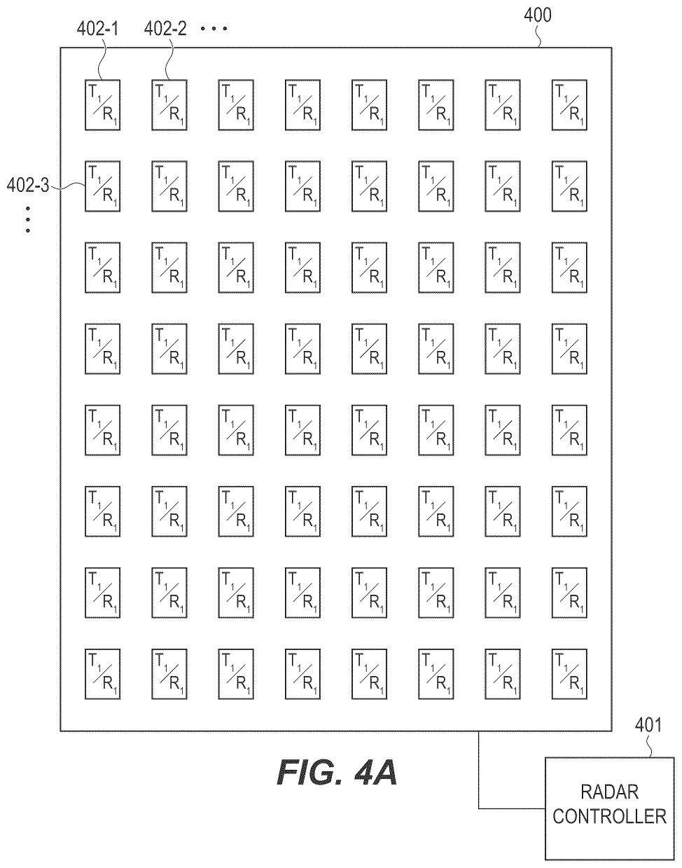

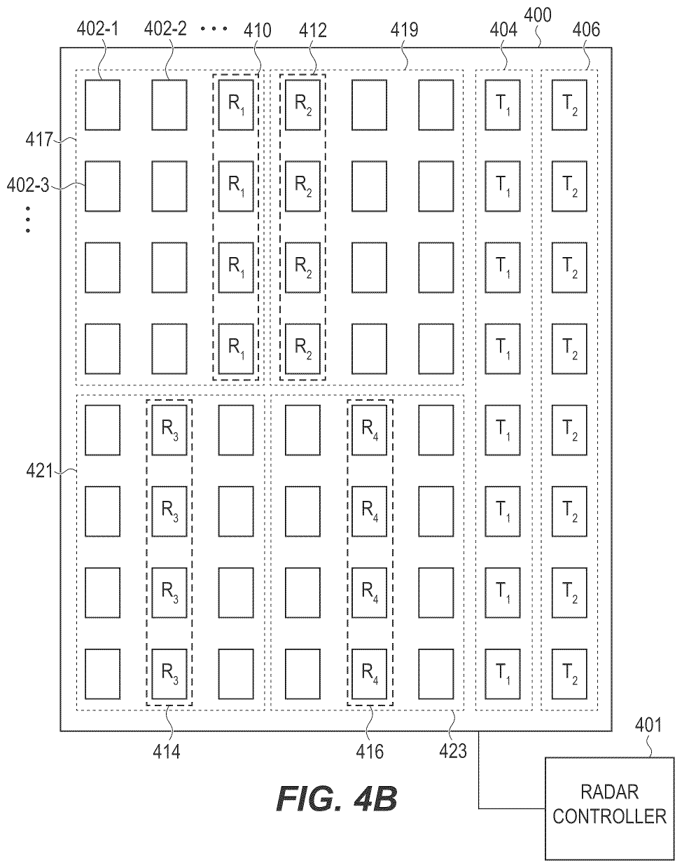

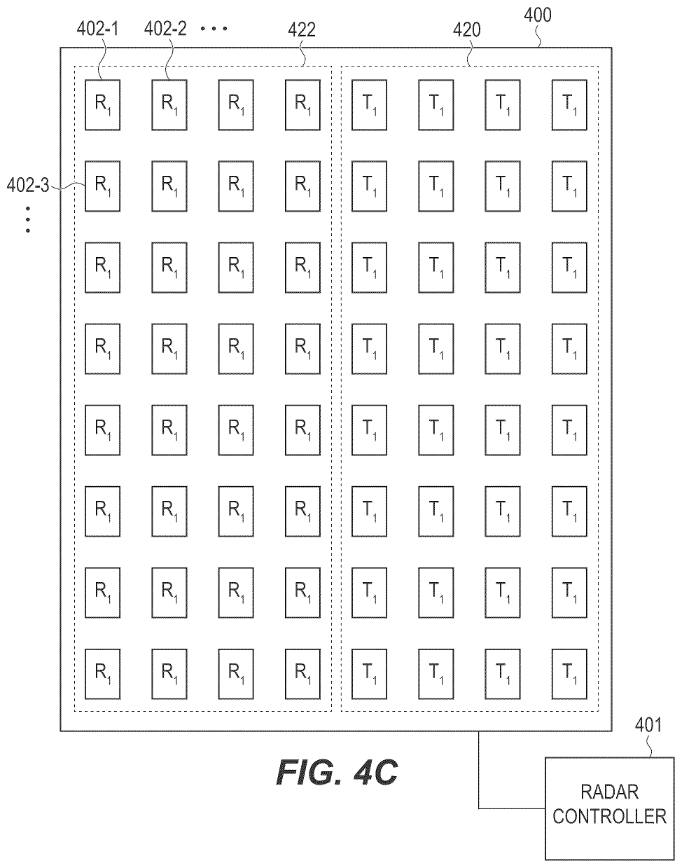

FIG. 4A illustrates an example two-dimensional array of antenna elements 400 (referred to simply as the array 400), that may be used by a multi-mode radar system 117. As described herein, the array 400 may be operable in multiple modes during different phases of a mission or flight. The array 400 may be configured for operation in any suitable radar band, including but not limited to W Band (75-110 GHz), V Band (40-75 GHZ), Ka-band (26-40 GHz), Ku-band (12-18 GHz), X-band (8-12 GHz), C-band (4-8 G Hz), S-band (2-4 GHz), L-band (1-2 GHz), or other established radar bands.

The array 400 includes antenna elements 402 (e.g., 402-1, . . . , 402-n), arranged in a two-dimensional array. As shown, the array 400 is an 8×8 array of antenna elements, though this is merely one example, and more or fewer radiating elements may be used, and in different two-dimensional arrangements (e.g., non-square arrays).

The antenna elements 402 may act as radio frequency antenna elements for transmitting and receiving radio frequency signals. The antenna elements 402 may be operatively coupled to a radar controller 401, which controls the functions and/or operations of the antenna elements 402. Each antenna element 402 may be independently controllable by the radar controller 401, such that the particular function of each antenna element 402 can be selected depending on the mode of operation of the radar system as a whole.

The radar controller 401 may include hardware and software components to provide the functionality of the multi-mode radar systems described herein. For example, the radar controller 401 may include transmitter components, receiver components, signal or waveform generators (e.g., to generate the signals that are transmitted by antenna elements operating in a transmit mode), signal processing components, timing and synchronization components, and the like. The radar controller 401 may be operatively coupled to and cooperate with other systems of an aircraft (e.g., an aircraft computing system, flight management system, RGMS, etc.) to change between radar modes. For example, the radar controller 401 may receive information indicating an aircraft mode, phase, or operation, and select a radar mode based on the information. In some cases, the mode that is selected by the multi-mode radar system for a given mode, phase, or operation may be predetermined (e.g., ground-based transit corresponds to a MIMO mode, transition operations correspond to an alternating mode, and airborne transit corresponds to a pulsed mode).

FIG. 4A illustrates an example operational configuration of the antenna elements 402 of the array 400 during a pulsed radar mode. As described herein, the pulsed radar mode may be used during airborne operations and/or other operations where greater range is desired (and where a higher power output is acceptable) (e.g., FIGS. 3C-3D). As shown, each antenna element 402 may be operated in a transmit mode for a first duration, and in a receive mode for a second duration. During the transmit mode, the antenna elements 402 emit an RF signal or pulse, which propagates away from the array and may be reflected back towards the array (at least partially) by external objects. After the first duration, the antenna elements 402 cease transmitting, and are operated in a receive mode, in which they may receive reflections of the emitted RF signal. The cycle of transmitting and receiving in transmit and receive modes may be repeated to effectuate the pulsed radar mode.

In the pulsed radar mode, the multi-mode radar system may determine a distance to an object by analyzing the time delay between the transmitted and received signals (e.g., a time of flight). By measuring the time it takes for the signal to travel from a transmitter group to the object and back to the receiver group, the radar system may calculate the round-trip time, which is proportional to the distance between the radar array and the object. Further, the multi-mode radar system may detect the position of an object (e.g., azimuth angle and an elevation angle, or any other positional representation) in the pulsed radar mode using techniques such as beamforming, antenna scanning, electronic scanning, doppler analysis, and the like.

FIG. 4B illustrates an example operational configuration of the antenna elements 402 of the array 400 during a MIMO radar mode. As described herein, the MIMO radar mode may be used during ground-based operations and/or other operations where a shorter range is acceptable, and where high positional accuracy and low power output is advantageous. As shown, a first subset 404 of the antenna elements and a second subset 406 of the antenna elements are operated in a transmit mode, while at least a third subset 410 and a fourth subset 412 are operated in a receive mode. In some cases, additional subsets 414, 416 are operated in the receive mode, and additional subsets are operated in the transmit mode.

In the MIMO mode, antenna elements that are not being operated a transmit or receive mode may be inactive. For example, such antenna elements may neither be emitting RF signals, nor receiving RF signals (e.g., they are not being used by the radar system or radar controller for processing or detecting reflected RF signals).

In some cases, the subsets of the antenna elements are one-dimensional arrays (e.g., linear arrays). As shown, each subset includes at least a portion of a column of the antenna elements (e.g., a vertical array), though other arrangements are also possible. Additionally, in some cases (as shown in the example of FIG. 4B), columns of antenna elements being operated in a transmit mode may be adjacent columns, and columns of antenna elements being operated in a receive mode may be adjacent column.

In some cases, the antenna elements in a given subset are operated as a unified antenna group, such that the signals received at the antenna elements in a given receiver group are treated as a single received signal, and the signals transmitted by the antenna elements in a given transmitter group are treated as a single emitted signal. The receive groups and transmit groups, which are defined by subsets of the array 400 of antenna elements as shown, may be referred to as receive groups R1, R2, R3, and R4, and transmit groups T1, T2. In some cases, the signals received at a receive group are digitized or processed as a group, such that the receive group (of multiple antenna elements) corresponds to a single received signal, for the purposes of processing by the radar controller.

In some cases, the array may be functionally grouped into signal groups (e.g., quadrants) 417, 419, 421, 423, which are each digitized or processed as a group, such that each signal group produces a single signal (corresponding to reflected RF signals) for analysis by the controller 401. This also allows the radar controller 401 to activate or deactivate different antenna elements in a given signal group or quadrant to achieve a different radar performance characteristics depending on the particular needs. For example, by activating additional or different antenna elements in a signal group (e.g., accepting and/or processing RF signals received at those antenna elements), the radar may achieve different radar performance characteristics (e.g., different field of regard, different lobes, different primary sensing direction, etc.).

The operational configuration of the antenna elements 402 shown in FIG. 4B may facilitate or enable a MIMO radar mode, in which there are multiple groups of antenna elements transmitting RF signals, and multiple groups of antenna elements receiving RF signals. In some cases, the antenna elements operating in transmit modes are continuously emitting the RF signals, while those in the receive mode are continuously receiving reflected RF signals. Additionally, each receiver group R1-R4 may receive reflected signals from each transmitter group T1-T2. Moreover, each transmitter group may emit different signals (e.g., different frequencies, different waveforms, etc.), such that the radar controller 401 can determine which transmitter group a particular signal received at a receiver group originated from. Based on the relative positions of the transmitter and receiver groups, and the particular characteristics of the received RF reflections, the radar controller 401 can determine position information of the external objects.

The groups of antenna elements (e.g., the subsets of the array) may be spatially separated along one or more dimensions of the array 400, such that the radar system (e.g., the radar controller 401) can operate the array 400 as a phased array to determine position information of external objects. For example, the transmitter groups may be separated from the receiver groups along a horizontal direction. The particular positioning of the transmit and receive groups (e.g., their horizontal separation distances) may define or affect radar parameters, such as the field of regard, the range, the positional resolution (e.g., in a horizontal or azimuthal direction), or the like, of the radar system.

As shown, the receive groups include two receive groups R1, R2 that have a first spatial separation, and two receive groups R3, R4 that have a second spatial separation different from (e.g., greater than) the first spatial separation. This configuration may provide different radar performance characteristics as compared to operating the array with only one pair of receive groups. For example, different spatial separations of the receive groups may produce different radar lobes, which may affect various radar performance parameters. The particular number of discrete receive groups and their spatial separations (in either the horizontal or the vertical directions) may be selected to provide a desired set of radar performance and/or operational characteristics.

In some cases, the receive groups are also vertically separated. For example, the receive groups R1, R2 are vertically separated from receive groups R3, R4. This configuration may provide greater field of regard or positional resolution in a vertical or elevational direction.

The radar controller 401 may use various processing techniques in order to operate the array in the MIMO mode. For example the radar controller 401 may operate the array as a phased array. In some cases, the radar controller 401 may use time difference of arrival techniques to determine a position of an object (or other information). For example, the radar controller 401 may determine a position of an object based at least in part on a time difference of arrival of a reflected portion of a signal at two different receive groups.

In the MIMO mode, the multi-mode radar system may determine the position of an object based at least in part on the reflected signals (e.g., their time of arrival, angle of arrival, frequency, doppler shift, etc.) and the relative distances between (and/or positions of) the transmitter groups and the receiver groups (and/or the antenna elements in the transmitter groups and the receiver groups). More generally, in the MIMO mode, the radar system may leverage the spatial diversity of the transmitter and receiver groups to determine the position of objects, and may use analysis and algorithmic techniques such as beamforming, space-time adaptive processing, time of flight analysis, time-distance of arrival analysis, and the like.

FIG. 4C illustrates another example operational configuration of the antenna elements 402 of the array 400. This configuration may correspond to a frequency modulated continuous wave (FMCW) radar mode. An FMCW radar mode may be used during certain aircraft operations. In some cases, the FMCW radar mode may have an intermediate range and power output as compared to MIMO and pulsed radar modes, and may be used during ground-based operations when greater range than a MIMO mode is needed, and may be used during airborne flight when a higher update rate and a shorter blind range than a pulsed mode is needed.

As shown in FIG. 4C, a first subset 420 of the antenna elements are operated in a transmit mode and a second subset 422 of the antenna elements are operated in a receive mode. The first subset 420 may continuously output an RF signal, and the second subset 422 may be continuously operated in the receive mode. This may provide a greater refresh rate and shorter blind range than pulsed radar. In some cases, the radar may operate in various combinations of MIMO, FMCW, and pulsed radar modes. For example, during airborne phases of flight, the antenna may alternate or cycle between a pulsed mode and an FMCW mode. More particularly, the radar may operate in a pulsed mode for a first duration to detect long-range objects, weather, and/or other objects or phenomena, and then operate in an FMCW mode for a second duration to detect shorter-range objects (e.g., due to the smaller blind range and greater refresh rate). Other radar mode alternating schemes are also contemplated, such as transitioning between pulsed and MIMO modes (e.g., during transition phases such as takeoff, landing), transitioning between pulsed, MIMO, and FMCW modes, transitioning between MIMO and FMCW, and so forth.

Moreover, the particular set of modes that the radar transitions between may be associated with particular aircraft operations and/or modes, such as takeoff, landing, ground transit, flight, and the like.

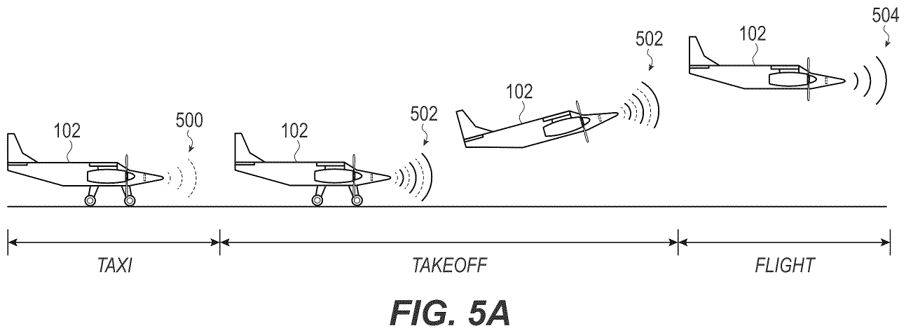

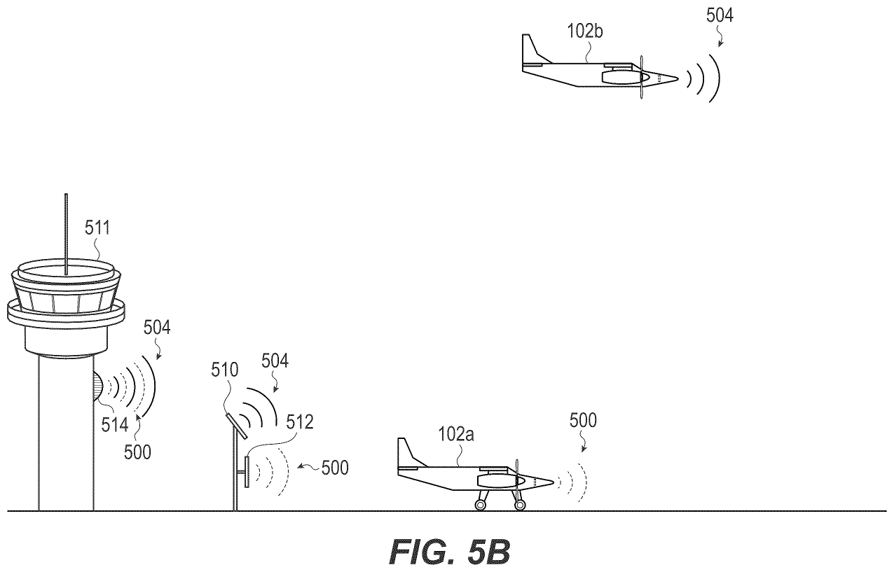

FIG. 5A depicts the aircraft 102 at different phases of a mission, illustrating how a multi-mode radar system 117 may be operated in different modes to provide different radar performance characteristics. FIG. 5A shows the aircraft 102 during a ground transit phase (e.g., the taxi operation), a transition phase (e.g., takeoff), and a flight phase. As described herein, each phase may be autonomous and may be defined by a validated route that is being traversed by the aircraft 102. During the ground transit phase, the multi-mode radar system 117 is operated in a first mode 500 (e.g., a MIMO mode as described with respect to FIG. 4B). As noted, this radar mode may reflect the radar performance requirements during ground transit (e.g., short range, low dead space, low power). During a transition phase such as takeoff (and also landing), the radar may operate in a hybrid mode 502, in which the radar alternates between the MIMO mode 500 and a pulsed mode 504 (and optionally other modes, such as FMCW mode). This may allow the multi-mode radar system 117 to detect both smaller and nearer ground-based obstacles, as well as airborne obstacles, thereby providing observational coverage of both the ground and air during the transition phase.

Where the multi-mode radar system operates in the hybrid mode, it may alternate at any suitable frequency, cycle, or pattern such as at a regular interval or frequency (e.g., 5 seconds MIMO mode, 5 seconds pulsed mode). In some cases, the interval and/or allocation between the MIMO and pulsed modes changes during the hybrid mode (e.g., throughout the transitional phase of the operation). For example, at the beginning of the transitional phase, the radar may operate at a 10:1 time cycle (e.g., 10 seconds MIMO, 1 second pulsed), and may gradually transition to a 1:10 time cycle at the end of the transitional phase. Other frequencies, time cycles, or manners of switching between radar modes are also contemplated, and other conditions or events that will cause the multi-mode radar system to change the relative allocation of pulsed and MIMO modes are also contemplated. For example, when an aircraft is travelling at a higher speed (during either flight or ground transit), the multi-mode radar system may allocate relatively more time to operating in the pulsed mode (e.g., to ensure that more distant objects are identified with adequate time to take corrective action). Conversely, when the aircraft is travelling at a lower speed, the multi-mode radar system may allocate relatively more time to operating in the MIMO mode.

When the aircraft is in the autonomous flight phase, the multi-mode radar system may operate in the second mode 504 (e.g., pulsed). In some cases, the radar operates exclusively in the second mode 504 during the flight phase, while in other cases it may transition to a different mode in response to events. For example, the multi-mode radar system may transition from a pulsed mode to an MIMO mode in response to detecting an object that satisfies a distance condition (e.g., the object is within or is likely to enter a threshold distance of the aircraft).

In some cases, the particular mode of operation used by a radar system is specified by the validated route that the aircraft is using for its autonomous flight. For example, the validated route (as generated by an RGMS and being executed by the aircraft) may specify which radar mode should be used during which portions of the route. For example, the route may specify a first radar mode (e.g., MIMO) during a first phase or segment of the route (e.g., taxiing, ground-transit, parking, etc.) and a second radar mode (e.g., pulsed) during a second phase or segment of the route (e.g., flight). The route may also specify whether the radar mode should alternate between radar modes, and at what frequency or other alternating scheme. In some cases, the multi-mode radar system or the aircraft more generally may override the specified radar mode in response to certain conditions or events, such as when a nearby object is detected during a pulsed radar mode (e.g., the radar may switch to a MIMO mode, FMCW mode, or the like).

Multi-mode radar systems as described herein may be used for ground-based installations as well. In particular, the multi-mode radar systems may provide a high degree of flexibility in radar performance parameters in a relatively small and efficient package. For example, a single radar unit can be switched between multiple modes (e.g., MIMO, pulsed, FMCW, etc.) in order to provide different performance for different purposes. FIG. 5B illustrates an example environment in which multiple multi-mode radar systems are provided in ground-based and aircraft-based installations. As shown, Multi-mode radar systems may be used in exclusively a single radar mode, or they may be selectively used in multiple radar modes based on automatic criteria (e.g., automatically changing between modes based on time intervals, detected events, and the like), or manually (e.g., by a human operator).

As shown in FIG. 5B, aircraft 102a includes a multi-mode radar system operating in a first (e.g., MIMO) mode 500 during ground transit, and aircraft 102b includes a multi-mode radar system operating in a second (e.g., pulsed) mode 504 during flight. FIG. 5B also illustrates ground-based multi-mode radar systems 510 and 512, which may be mounted to a fixed or movable structure. The multi-mode radar system 510 may be oriented in a direction to preferentially detect airborne objects, and as such may be configured to operate exclusively (or primarily) in a particular radar mode (e.g., the second or pulsed mode 504, or other long-range detection mode). By contrast, the multi-mode radar system 512 may be oriented in a direction to preferentially detect ground-based objects, and as such may be configured to operate exclusively (or primarily) in a particular mode (e.g., the first or MIMO mode 500, or other short-range detection mode). In some cases, a multi-mode radar system may be mounted on an articulatable structure such that the array may be aimed in different directions (either automatically, in response to the multi-mode radar system detecting an event or condition, or manually, in response to a user input).

A multi-mode radar system 514 may also be used in a ground-based installation 511 (e.g., on a building, structure, or the like), and may be operated in multiple modes. For example, the multi-mode radar system 514 may be configured to alternate between the MIMO mode 500 and the pulsed mode 504 (e.g., cyclically, periodically, or according to any alternating scheme). Further, as described herein, the multi-mode radar system 514 may automatically change between modes in response to the multi-mode radar system 514 detecting an event or condition, or may be manually changed in response to a user input. By alternating between modes, the multi-mode radar system 514 may provide a wide range of object detection capabilities and generally increase the performance of the system by providing both long-range detection and short-range detection (with high positional accuracy and fast update rate).

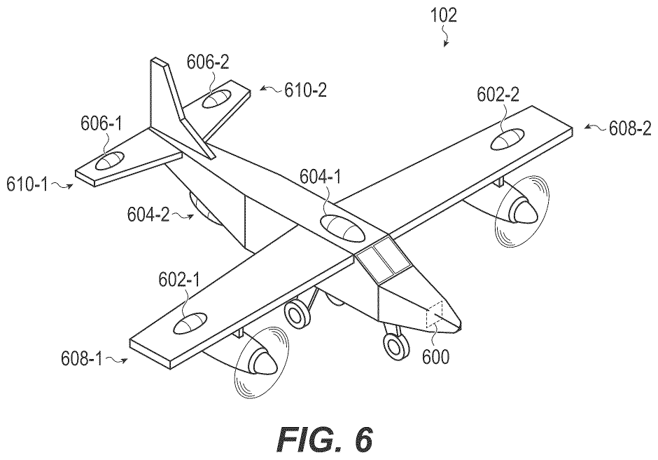

Multi-mode radar systems may be mounted to an aircraft in various locations and in various orientations in order to provide a desired radar coverage area around the aircraft. FIG. 6 illustrates the aircraft 102 with example multi-mode radar system installations. For example, a multi-mode radar system 600 may be installed in a nose cone or nose portion of the aircraft 102. The multi-mode radar system 600 may be generally oriented forward (e.g., along a longitudinal axis of the fuselage). More particularly, a plane or facing surface of the two-dimensional array may be facing forward.

FIG. 6 illustrates other potential installation locations for multi-mode radar systems. For example, multi-mode radar systems 602-1, 602-2 may be mounted on the tops of the wings, multi-mode radar systems 608-1, 608-2 may be mounted on the bottoms of the wings, multi-mode radar systems 604-1, 604-2 may be mounted to the fuselage (e.g., along the top or bottom of the fuselage, respectively), multi-mode radar systems 606-1, 606-2 may be mounted on the tops of the stabilizers, multi-mode radar systems 610-1, 610-2 may be mounted on the bottoms of the stabilizers. Any suitable combination of multi-mode radar systems mounted in these locations (or other locations not specifically illustrated) may be used. The radar installations shown in FIG. 6 may also include multiple multi-mode radar systems and/or multiple arrays oriented in different directions to provide the desired radar coverage. For example, the multi-mode radar systems 602-1, 602-2 may each include a forward-facing array and a rearward facing array. As another example, the multi-mode radar system 604-1 may include forward, rearward, and outward (e.g., left and right) facing arrays.

As described herein, the multi-mode radar systems may switch between various modes of operation and/or tracking configurations in response to various conditions, events, schedules, or the like. For example, as described with reference to aircraft-mounted radar systems, the radars may change between MIMO and pulsed modes in different phases of a mission or in response to other detected events. In some cases, a multi-mode radar system, whether in a ground-mounted or aircraft-mounted, may alternate between or among various additional modes and/or tracking functions. For example, a ground-mounted multi-mode radar system may be cyclically operated for a first duration in a pulsed mode to detect airborne objects, for a second duration in a MIMO mode to detect ground-based objects, and for a third duration in a weather mode. The multi-mode radar system may cease operating in one or more of the modes or may change the relative time allocation to a given mode based on certain conditions or events. For example, in response to detecting an increase in detected airborne or ground-based objects, the multi-mode radar system may reduce the time allocated to the weather mode (or cease operating in the weather mode altogether). As another example, in response to detecting dangerous weather conditions, the multi-mode radar system may reduce the time allocated to ground-based object detection.

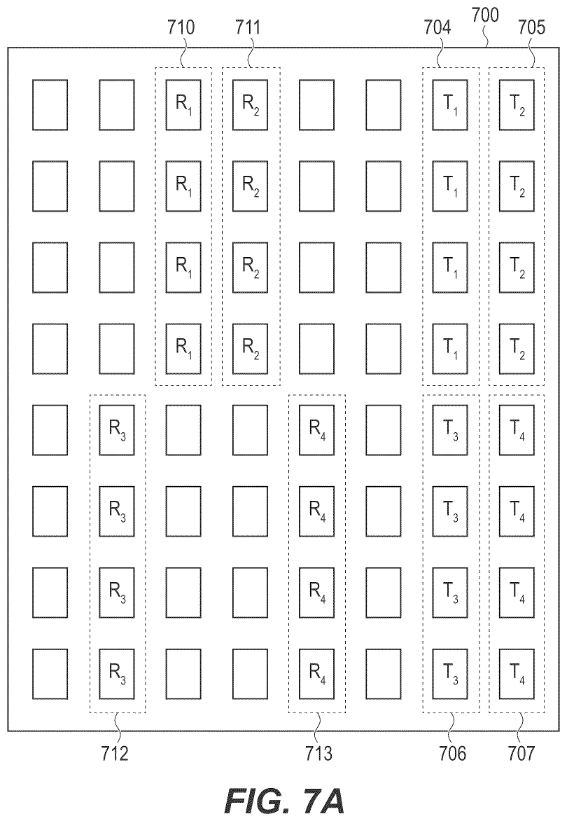

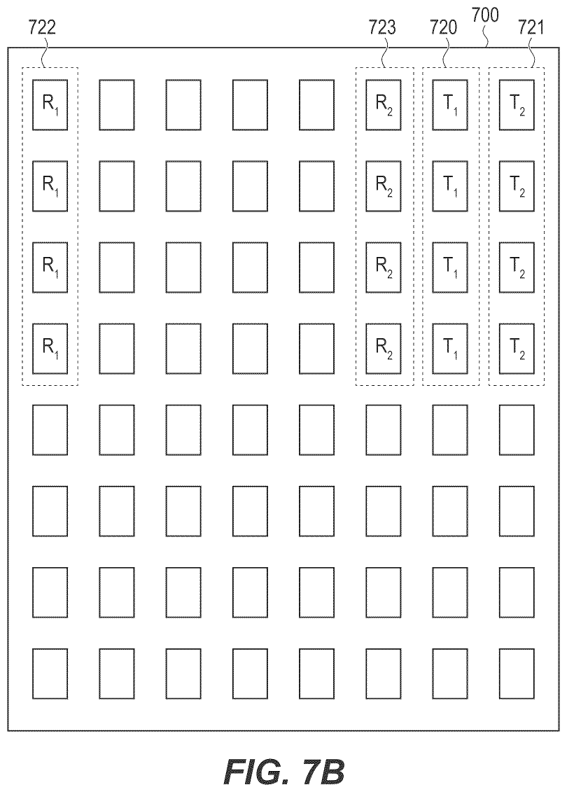

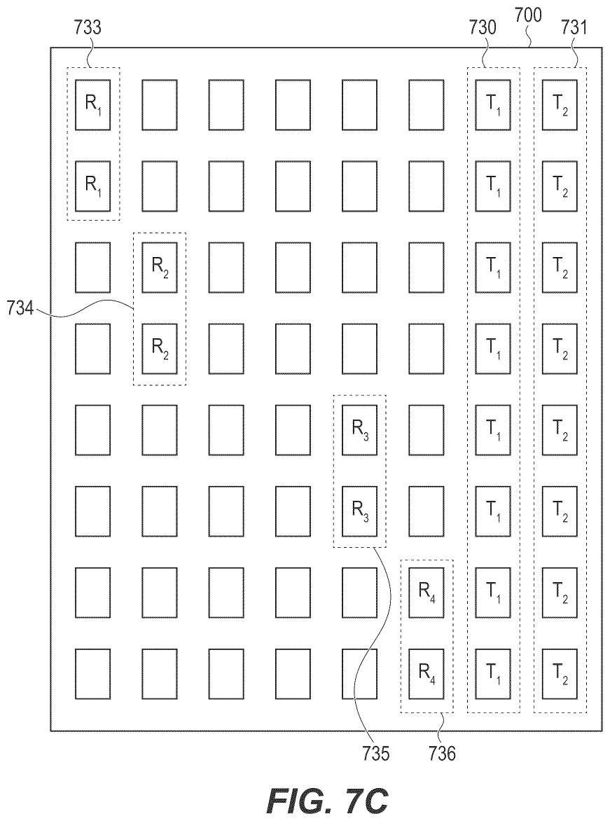

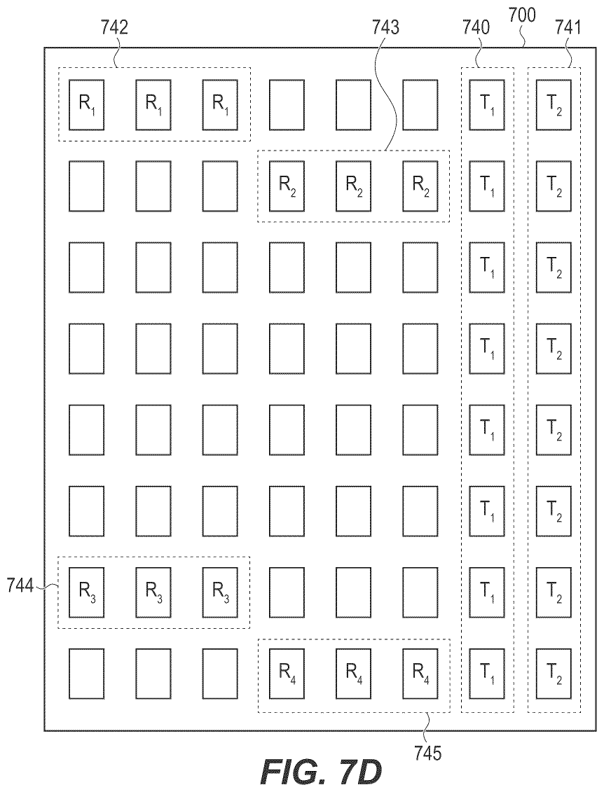

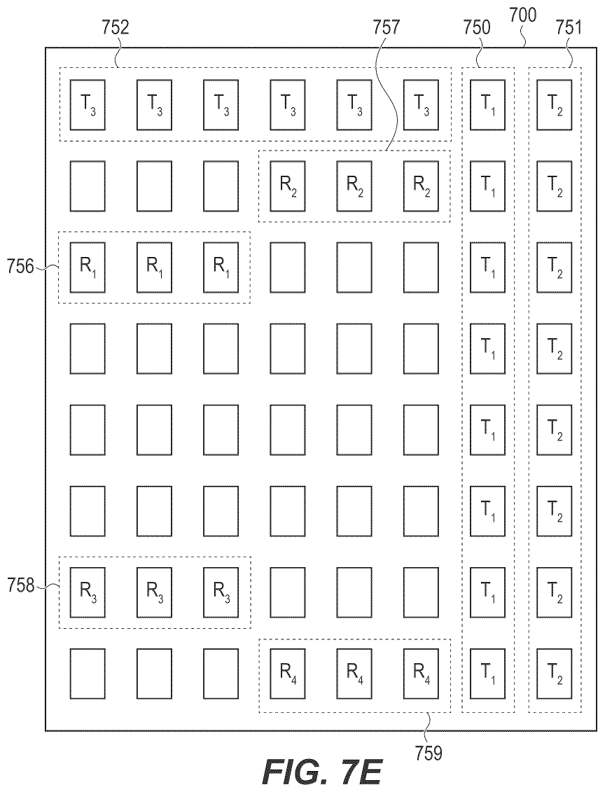

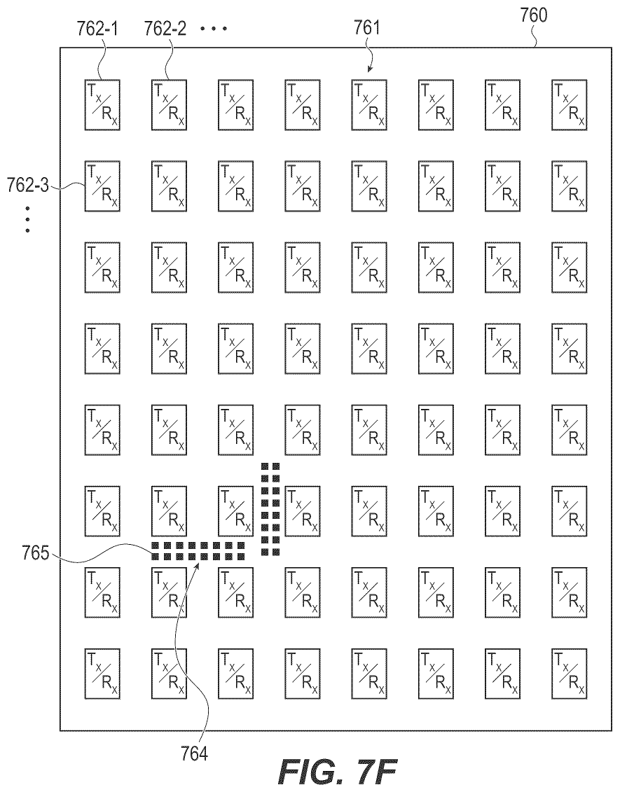

As described herein, multi-mode radar systems include arrays with separately addressable and/or controllable antenna elements, allowing the radar system to selectively use any antenna element (or combinations of elements) for transmitting or receiving. As described, this functionality allows the radar to be switched between various modes, such as MIMO, pulsed, FMCW, and the like. Further, while FIG. 4B illustrates one example configuration of antenna elements for use in a MIMO mode, multi-mode radar systems as described herein may use other configurations of antenna elements, and/or may switch between different configurations to provide different radar performance. For example, some configurations may provide different fields of regard (including different combinations or balances between vertical and horizontal angle), different ranges, different positional accuracy or resolution, and the like. FIGS. 7A-7E illustrate several nonlimiting examples of antenna element configurations that may provide different radar performance.

As shown in FIG. 7A, four subsets 704-707 of the antenna elements of an array 700 are operated in a transmit mode, while four subsets 710-713 are operated in a receive mode. The array 700 may correspond to or be an embodiment of the array 400. The subsets of the antenna elements may be one-dimensional arrays (e.g., linear arrays). As shown, each subset includes at least a portion of a column of the antenna elements (e.g., a vertical array), though other arrangements are also possible. As described herein, the antenna elements in a given subset may be functionally grouped together, such that the signals received at the antenna elements in a given receiver group are treated as a single received signal, and the signals transmitted by the antenna elements in a given transmitter group are treated as a single emitted signal. In some cases, the antenna elements operating in transmit modes are continuously emitting the RF signals, while those in the receive mode are continuously receiving reflected RF signals. Additionally, each receiver group R1-R4 may receive reflected signals from each transmitter group T1-T2, and each transmitter group may emit different signals (e.g., different frequencies, different waveforms, etc.), such that a radar controller (e.g., the radar controller 401) can determine which transmitter group a particular signal received at a receiver group originated from. Based on the relative positions of the transmitter and receiver groups, and the particular characteristics of the received RF reflections, the radar controller 401 can determine position information of the external objects. As compared to the configuration shown in FIG. 4B, the configuration in FIG. 7A may provide different radar performance by providing additional vertically-separated transmitter groups.

FIG. 7B illustrates an example configuration that uses fewer antenna elements. This may be used, for example, where lower power output is desired. In this example, two subsets of antenna elements 720, 721 are operated in a transmit mode, while two subsets 722, 723 are operated in a receive mode. In this example, each transmit group includes only four antenna elements, though other numbers of antenna elements are also contemplated (e.g., fewer than a full column of antenna elements). As in other examples, the subsets of the antenna elements may be one-dimensional arrays (e.g., linear arrays). As shown, each subset includes at least a portion of a column of the antenna elements (e.g., a vertical array), though other arrangements are also possible.

FIG. 7C illustrates an example configuration in which two subsets of antenna elements 730, 731 are operated in a transmit mode, while four subsets 733-736 are operated in a receive mode. In this example, the receive groups include fewer antenna elements and have a different spatial arrangement, thus providing different radar performance parameters. As in other examples, the subsets of the antenna elements may be one-dimensional arrays (e.g., linear arrays). As shown, each subset includes at least a portion of a column of the antenna elements (e.g., a vertical array), though other arrangements are also possible.

FIG. 7D illustrates an example configuration in which two subsets of antenna elements 740, 741 are operated in a transmit mode, while four subsets 742-745 are operated in a receive mode. In this example, the receive groups include one-dimensional horizontal arrays of antenna elements, each spatially separated by horizontal and vertical distances. The horizontal arrays may provide different radar performance parameters as compared to other arrangements described herein. As in other examples, the subsets of the antenna elements may be one-dimensional arrays (e.g., linear arrays), and may include both horizontal and vertical linear arrays.

FIG. 7E illustrates an example configuration in which three subsets of antenna elements 750, 751, 752 are operated in a transmit mode, while four subsets 756-759 are operated in a receive mode. This example illustrates that the combinations of vertical and horizontally oriented groups of antenna elements may be used in combination. For example, as shown the transmit groups include two vertical one-dimensional arrays and one horizontal one-dimensional array. Also, the receive groups include one-dimensional horizontal arrays of antenna elements, each spatially separated by horizontal and vertical distances.

In some cases, a multi-mode radar system may include antenna elements that are configured to operate in different radar bands and/or frequencies. For example, FIG. 7F illustrates an array structure 760 that includes a first array 761 of antenna elements 762, and a second array 764 of antenna elements 765. The first array 761 may correspond and/or be operated in the same or similar manner as other two-dimensional arrays described herein (e.g., the arrays 400, 700).

The first array 761 may be configured for operation in a first radar band (e.g., a first frequency, such as 9 GHz, or the like), and the second array 764 may be configured for operation in a second radar band (e.g., a second frequency band, such as 60 GHz, 77 GHz, 94 GHZ, or the like). The different frequency bands of the arrays may generally correspond to or require different sizes of antenna elements. Thus, the antenna elements for the second frequency band may be smaller than the antenna elements for the first frequency band. As such, the second array 764 may be positioned between and/or among the antenna elements of the first array (e.g., on the same substrate). In some cases, the second array 764 may have different radar performance characteristics than the first array 761. For example, the second array 764 may have a greater ability to identify small objects, and may have a lower power output than the first array.

Either or both of the first array 761 and the second array 764 may be operated in multiple modes. In some cases, the arrays 761, 764 may be operated simultaneously, or a multi-mode radar system may switch between which array is active based on conditions or events, as described herein (e.g., based on the phase of a flight operation or mission, in response to detecting objects that satisfy a position or range condition, etc.). In some cases, both the first and second array are operable in pulsed and MIMO modes, among other possible modes.

While FIG. 7E illustrates one example arrangement for the array 764, other arrangements are also contemplated, including sparse arrays, uniform linear arrays, uniform rectangular arrays, planar arrays, and the like.

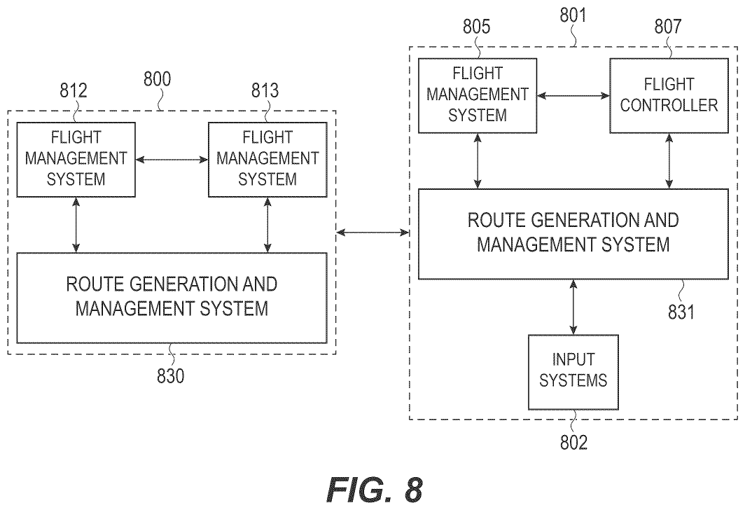

FIG. 8 depicts a schematic view of an example ground station 800 and an example aircraft 801. The ground station 800 of FIG. 8 corresponds to the ground stations 200 of FIG. 2 and 110 of FIG. 1 and is configured to facilitate control and communications with the aircraft 801. The aircraft 801 corresponds to the aircraft 102.

In general, the ground station 800 is a system that generates validated routes (and/or validates routes) and provides validated routes that are executed only with an affirmative or explicit action taken by an authenticated user using a dedicated control (e.g., the control element 222 of FIG. 2). The schematic view and operation of the ground station 800 is provided by way of example and use of the system may vary depending on the implementation and the scenario. For example, not all instructions require an affirmative or explicit confirmation and some commands or instructions performed using the ground station 800 do not require an authenticated user. Other variations on the following example operations may also be implemented using the ground station 800.

As shown in FIG. 8, the ground station 800 includes dual flight management systems 812, 813 which may be operated in tandem. For example, operations initiated on the first flight management system 812 may be replicated on the second flight management system 813 allowing for redundant computation, storage, and execution of the various flight management operations.

The aircraft 801 may include an onboard RGMS 831, an onboard flight management system 805, a flight controller 807, and input systems 802. As described herein, the RGMS 831 may generally perform the same or similar operations as the RGMS 830, and may be configured to maintain redundancy with (and maintain the same operational state and information) as the ground-based RGMS 830. The RGMS 831 may be an embodiment of the RGMS 111 (FIG. 1). The flight management system 805 may perform the same or similar operations as the flight management systems 812, 813, and may be configured to maintain redundancy with (and maintain the same operational state and information) as the ground-based flight management systems. The flight management system 805 may be one of a pair (or more) of redundant flight management systems onboard the aircraft 801. The aircraft 801 may also include a flight controller 807, which may be an embodiment of the flight controller 109 (FIG. 1) and may be configured to operate the propulsion system and various flight control surfaces of the aircraft 801.

The aircraft 801 may also include input systems 802 that are manipulatable by operators to produce route modification requests. The input systems 802 may include an inceptor, such as a joystick or other manipulatable lever or system that a user can interact with to provide inputs that have a direction component and a magnitude component.

The RGMS 830 may receive inputs from the input systems 802 and may interface with the onboard flight management system 805 and/or the flight controller 807 to perform the operations described herein.

As used herein, the onboard and ground-based RGMS may be redundant systems (e.g., each providing the same or overlapping functionality), or they may otherwise cooperate to provide the functions of the RGMS as described herein. Accordingly, as used herein, an RGMS may refer to either an onboard RGMS, a ground-based RGMS, or both the ground-based and onboard RGMS. Moreover, the functions of the RGMS may be provided by a computing system or service or a combination of computing systems or services.

In some cases, the dual flight management systems 812, 813 may receive flight plans from an operator. For example, the flight management systems may provide user interfaces and other controls to allow a user to define a proposed flight plan. The RGMS 830 may access the proposed flight plan and generate a valid route that satisfies the flight plan. In some cases, proposed flight plans may be provided to the RGMS 830 via other input systems, bypassing the flight management systems. For example, in some cases, the RGMS 830 provides a graphical user interface that a user may interact with to provide a flight plan. The RGMS 830 may be operatively coupled to components and systems of a ground station (e.g., the ground station 200, including the flight management systems, displays, input devices, etc.) to facilitate user interaction with the RGMS.

A route generated from a flight plan (or otherwise configured to satisfy a flight plan or other flight objective(s)) may define a full three-dimensional trajectory for an aircraft to traverse in order to complete a flight. A route may include and/or specify all aircraft maneuvers and operations from an origin static location (e.g., hanger, apron, ramp, parking spot, etc.) to a destination static location (e.g., hanger, apron, ramp, parking spot, etc.), and may include departure taxiing, takeoff, flight, landing, and arrival taxiing. For example, a route may define the path along the ground that an aircraft will traverse in order to travel from an initial static (e.g., ground) location to a takeoff location, the path through the air (including any flight maneuvers and/or navigation sequences such as turns, altitude changes, etc.) from takeoff to landing, and the path along the ground in order to travel from a landing location to a destination static (e.g., ground) location. The route may also include or define other parameters, such as target speeds, target accelerations, and the like. A route may also include alternate routes or contingencies for varying flight conditions (e.g., weather changes, air traffic, fuel level) that may be monitored using sensors or other telemetry onboard the aircraft.

The RGMS 830, 831 produce validated routes (e.g., routes that satisfy a flight plan) and may ultimately provide the validated routes to a flight controller of an aircraft in order to initiate or otherwise allow the aircraft to traverse the validated route. In order to qualify as a validated route, the route must be safe (according to one or more safety criteria), and the aircraft must be capable of traversing the route (e.g., the maneuvers and operations defined by the route are fully within the aircraft's operational envelope). For example, for a route to be validated, it must not intersect known obstacles, such as terrain, landforms, buildings, the ground, or the like. Determining whether the route intersects known obstacles may include accessing maps, charts, geographical data, or any other suitable information in order to determine the location of obstacles and determine whether they will interfere with the proposed route. Such information may be stored in a database or other data store and accessed by the RGMS 830 for analysis when generating a validated route. Accordingly, generating a validated route includes generating a route that satisfies a set of validity criteria (which may be specific to different aircraft, missions, geographic locations, etc.).

Generating a validated route may also include generating a route that the particular aircraft for which the route is intended is capable of performing the route. For example, the RGMS 830 may generate a route that is within the aircraft's operational envelope (including but not limited to a maximum altitude, maximum speed, stall speed, turn rate, climb rate, etc.).

In some cases, the RGMS 830 may validate proposed routes or route modifications. Proposed routes may be provided to the RGMS 830 or another system or service (e.g., from user input, a route generation service, or the like), and the RGMS 830 may separately validate the proposed route. Route modifications may be generated by a user manipulating an inceptor on an aircraft, as described herein. Validating a proposed route or route modification may include determining or confirming that the route satisfies the same validation criteria as any other validated route, including determining that the route is safe (according to one or more safety criteria), and that the aircraft is capable of executing the route (e.g., the route is fully within the aircraft's operational envelope). For example, validating a proposed route or route modification may include determining whether the route intersects known obstacles, such as terrain, landforms, buildings, the ground, or the like. Determining whether the route intersects known obstacles may include accessing maps, charts, geographical data, or any other suitable information in order to determine the location of obstacles and determine whether they will interfere with the proposed route. Such information may be stored in a database or other data store and accessed by the RGMS 830 for analysis when validating a route.

Validating a proposed route or route modification may include determining whether the particular aircraft for which the route is intended is capable of performing the route. For example, the RGMS 830 may confirm that the route is within the aircraft's operational envelope (including but not limited to a maximum altitude, maximum speed, stall speed, turn rate, climb rate, etc.). In some cases, as described herein, validating a route modification also includes determining whether the aircraft can safely return to a primary route after a deviation from the primary route.

As described herein, a proposed route modification, or a request for a new validated route or new segment of a validated route, may be provided by a multi-mode radar system (or initiated in response to information obtained by the multi-mode radar system, such as the presence of external objects and/or a predicted adverse encounter). In some cases, the RGMS may receive the proposed modification or the request and generate a validated route that avoids the object or adverse encounter. For example, the RGMS may generate a validated route that directs the aircraft to an area where no obstacles are detected.

Once a validated route is generated, or a proposed route or route modification is validated (e.g., all validation criteria are satisfied), the route may ultimately be provided to a flight controller of an aircraft. In some cases, the validated route may be sent to the flight controller 807 and/or or the RGMS 831 of the aircraft. The flight controller 807 may then communicate with or otherwise control the operation of various aircraft systems in order to cause the aircraft to traverse the validated route. While the foregoing illustrates one example process for generating routes and/or validating proposed route and route modifications (and for ultimately providing the validated route to the systems that execute the aircraft operations to traverse the route), this is merely one example, and other processes are also contemplated.

As used herein, a validated route may represent a path or trajectory (e.g., the complete trajectory through three-dimensional space) between an origin location (e.g., an origin airport) and a destination location (e.g., a destination airport), and which satisfies one or more validation criteria. In some cases, an aircraft cannot initiate a route until and unless a validated primary route is in place (e.g., stored in an onboard RGMS, flight controller, or the like). The primary route may be deviated from, as described herein, but the aircraft may be configured to return to or otherwise complete the validated route in the absence of other overriding inputs (e.g., a request or command to cancel the primary validate route and take manual control of the aircraft).

As described herein, onboard (or in some cases ground-based) operators may wish to temporarily deviate from a primary route. Instead of a fully manual override of the autonomous flight systems, the techniques described herein allow for an operator to introduce a route deviation via a simple physical input that resembles a conventional flight control mechanism (e.g., an inceptor), but that actually causes a route deviation to be proposed to the RGMS for validation and autonomous execution. For example, as described herein, an operator may wish to initiate a turn that represents a deviation from the validated primary route. In such cases, the user may simply manipulate an inceptor (e.g., pivoting the inceptor in the direction of the desired turn). The manipulation of the inceptor may result in a request to the RGMS (either to the onboard RGMS 831 or the ground-based RGMS 830, or both) to compute a modified route with a predetermined flight maneuver. More particularly, as described herein, the manipulation of the inceptor may be mapped to a predetermined flight maneuver, such as a constant radius turn or a climb with a constant climb rate, and the RGMS may compute and validate a modified route that includes the predetermined flight maneuver.

The RGMS interprets the input from the inceptor as a proposal for a modified route, where the modification includes a predetermined flight maneuver that represents a deviation from the primary route. In response to receiving the input, the RGMS may map the input to a predetermined flight maneuver, and compute a modified route based at least in part on the predetermined flight maneuver. The RGMS may map the input to a predetermined flight maneuver based at least in part on the direction and the magnitude of the input to the inceptor. For example, the RGMS associates the direction and magnitude of the input to a particular predetermined flight maneuver, such as a 860-degree constant radius turn, an ascent, or a descent. For example, a stick manipulation in a lateral direction may indicate a turn in that direction, and the distance of the manipulation may be correlated to the turn radius. A stick manipulation in the fore/aft direction may indicate a change in altitude, and the distance of that manipulation may be correlated to a climb rate.

The RGMS may then validate the modified route that was generated in response to the inceptor input. Validating the modified route may include the same or substantially the same operations as validating the primary route, including, without limitation, determining whether the modified route intersects known obstacles, determining whether the proposed maneuvers are within the aircraft's operational envelope, and the like. In some cases, validating the modified route includes determining whether a valid path exists to return the aircraft to the primary route after the deviation is completed. In accordance with a determination that the proposed modified route satisfies the validation criteria (e.g., the route is valid), the modified route may be provided to the flight controller of the aircraft to cause the aircraft to traverse the modified route. In accordance with a determination that the proposed modified route fails validation criteria, (e.g., the route is not valid or not validated), the modified route may be disregarded or rejected. Thus, if the modified route is validated, the aircraft will execute the modified route, consistent with the operator's input to the inceptor. If the modified route is not validated, the aircraft will not execute the modified route (e.g., the modified route is disregarded), but will instead remain on the validated primary route. In this way, the operator can provide an intuitive flight-control style input, but the aircraft will not be under full manual control. Rather, the input results in a new validated route, which the aircraft executes autonomously. Moreover, at all times, the aircraft remains under autonomous control to traverse a validated route.

In some cases, when an RGMS receives a request for a modified route in response to objects detected by an multi-mode radar system, the RGMS may attempt to use one or more predetermined flight or ground-transit maneuvers in order to avoid or eliminate the potential adverse encounter. For example, in response to detecting (e.g., with the multi-mode radar system and/or associated aircraft systems) a potential adverse encounter, the RGMS may select a one or more predetermined maneuvers (e.g., one or more constant radius turns, an s-turn, a temporary change in altitude, or the like).

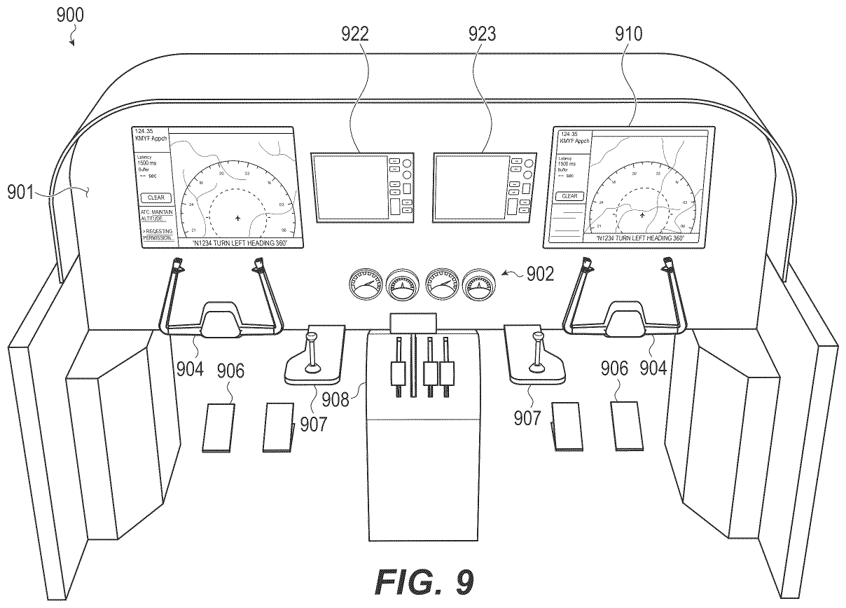

FIG. 9 depicts an example cockpit of an aircraft. As shown in FIG. 9, the aircraft 900 includes dual flight management systems 922, 923, which may be similar to the flight management systems 212, 213 and 812, 813 of FIGS. 2 and 8, respectively. The dual flight management systems 922, 923 may be similarly operated in tandem providing a level of redundancy and verification. The aircraft 900 also includes an instrument panel 901 that includes instruments 902 and other interface elements including a display interface 910. The instruments 902 may include computers, displays, dials, navigation equipment, communications equipment, and the like. When operated in a piloted or partially automated mode, the instruments 902 may also receive inputs from one or more onboard pilots or crewmembers to control various systems of the aircraft. The cockpit may also include various manual input systems for receiving physical inputs from a pilot or crewmember to control one or more aircraft systems. For example, the cockpit may include one or more yokes 904 (or control sticks or other structures). The yokes 904 may control flight control surfaces such as ailerons, elevators, ruddervators, stabilators, or the like. The cockpit may also include one or more sets of rudder pedals 906, which may control a rudder of the aircraft (or a ruddervator or other flight control surface).

The cockpit may also include one or more inceptors 907. An inceptor 907 may resemble a joystick or control stick and may be manipulatable by a user to provide directional inputs. The inceptor 907 may be separate from a yoke 904, as it may provide inputs to the RGMS of an aircraft system, rather than directly controlling flight control surfaces. The inceptor 907 may be manipulated in a manner similar to a control sick, with lateral (e.g., left/right) manipulations commanding turns, and fore/aft manipulations commanding changes in altitude. The inceptor 907 may include a haptic or tactile output system to provide tactile feedback to a user. The haptic output system may be configured to produce haptic outputs at predefined locations or manipulation distances, as described herein. In some cases, the haptic output system may include a haptic actuator, which may provide vibrational or other feedback via the inceptor 907. In some cases, the haptic output system includes a mechanical or electromechanical detent system that produces a resistance or other physical indication at certain manipulation distances. As described herein, the inceptor 907 may receive inputs that have a directional component and a distance or magnitude component, and information about the direction and magnitude may be provided to the RGMS (or other appropriate system) to request a particular deviation from a primary route (where the direction and magnitude of the input correspond to the desired direction and magnitude of the deviation). The inceptor 907 may be conveniently located so it can be manipulated by a user's hands while an operator is sitting in the cockpit.

In some cases, the inceptor 907 is not capable of manually or directly controlling the flight control surfaces or other systems of the aircraft. In other cases, the inceptor 907 may be operable in multiple modes, including a first mode in which the inceptor 907 is an input to the RGMS (manipulations act as inputs to the RGMS for route modifications), and a second mode in which the inceptor 907 acts as a flight control stick (e.g., the inceptor 907 controls the flight control surfaces of the aircraft).

The cockpit of the aircraft 900 may also include a flight control input assembly 908. The flight control input assembly 908 is conventionally where control levers for the propulsion system of an aircraft (e.g., a throttle control and power condition lever(s)) are positioned, and as such is also referred to as a throttle quadrant. The flight control input assembly 908 may include control levers and other input members (e.g., dials, buttons, knobs, etc.) that are manually manipulated by an onboard pilot or crewmember to operate the control systems of the aircraft. The flight control input assembly 908 may include control levers for controlling propulsion systems of the aircraft, flight control surfaces (e.g., flaps, elevator trim, air brakes), landing gear, or other aircraft systems.

The aircraft may also include a radio communication system for conducting radio-based communications with an ATC station, other aircraft, or other entities operating an appropriate radio. In some cases, the onboard radio communication system includes voice communications that are relayed from the operator of the ground station. The radio communication system may be broadly described as a VHF channel that is shared between an ATC facility or other ground-based station and any aircraft that are within a specified region or geographic boundary. In some cases, the radio communication system may be adapted for universal communications (UNICOM) and may be operating at one of a number of predefined frequencies. Typically, UNICOM channels used by large airports in the U.S. operate on a 122.950 MHz frequency band. Other airports may have ATC that operate on 122.700 MHZ, 122.725 MHz, 122.800 MHZ, 122.975 MHz, 123.0-00 MHz, 123.050 MHz, 123.075 MHz, or other frequency band. The UNICOM channel frequency bands and operational parameters may also vary by country, region, or other factor. The ATC facility or station may operate one or more Voice Communication Control Systems (VCCS) that are able to manage channel coupling, ground telecom links, telephone patching, and other functionality.

As described herein, an aircraft may be part of an aircraft operation system in which communication is facilitated between the aircraft and ground-based systems. FIG. 10 depicts a schematic of an example onboard system of an aircraft. Portions of the onboard system may include or be referred to as an aircraft computing system and may be programmed or configured to operate in accordance with a set of instructions or settings. As shown in FIG. 10, the onboard system 1000 includes a pair of communication modules 1012, 1013, which may include separate wireless transceivers that are configured to operate at frequencies used by the satellite subsystems, described above with respect to FIG. 1. The transceiver(s) of the communication modules 1012, 1013 may be adapted to conduct Ka-band communications (26-40 GHz), Ku-band communications (12-18 GHz), X-band communications (8-12 GHz), C-band communications (4-8 G Hz), S-band communications (2-4 GHZ), L-band communications (1-2 GHz), or other established communication bands. In some cases, the two communication modules 1012, 1013 are configured to operate over different frequency ranges to provide signal diversity for the system 1000.

As shown in FIG. 10, the system 1000 also includes flight management systems 1022, 1023, which correspond to the flight management systems 422, 423 of FIG. 4 (or any other onboard flight management systems described herein). As discussed previously, the flight management systems 1022, 1023 may be operated in tandem to provide increased reliability and redundant verification of operations. As shown in FIG. 10, each of the flight management systems 1022, 1023 are operably coupled to each of the communication modules 1012, 1013. This crossover between communication modules 1012, 1013 may be used to provide redundant communications to each of the flight management systems 1022, 1023 or, alternatively, may be operated in a fail-over condition in which the communication modules 1012, 1013 are each operably coupled to a single flight management system 1022, 1023 until a reliability condition is detected, which may include a failure of service, a reduction in the quality of service, an error rate that exceeds a criteria, or other measure of a change in predicted reliability. Each of the flight management systems 1022, 1023 may be configured to receive and process a flight plan or other flight commands generated by the ground station. For example, the flight management systems 1022, 1023 may receive, store, and display flight plans and may provide flight plan information to a flight controller, an RGMS, or other system(s) of the aircraft (e.g., to allow the RGMS to generate a route based on the flight plan, verify that a currently active route corresponds to or will ultimately result in the flight plan being accomplished, etc.).

As shown in FIG. 10, the system 1000 also includes an onboard aircraft computing system 1030. The aircraft computing system 1030 may include and/or instantiate various computing and other systems that provide flight and other functions described herein. For example, the aircraft computing system 1030 includes, instantiates, or is operably coupled to one or more subsystems including, without limitation, a flight controller 1032 (e.g., corresponding to the flight controller 109 or any other flight controller described herein), a route generation and management system 1033 (e.g., corresponding to the RGMS 111 or any other RGMS described herein), a communication system 1034, aircraft telemetry 1036, and one or more onboard camera systems 1038. The flight controller 1032 is configured to automatically operate one or more of the control systems normally operated by an onboard pilot and may be configured to control various actuators and actuation systems used to modify control surfaces of the aircraft, propulsion systems, landing gear, and other aircraft subsystems, as defined and/or required by a validated route. The communication system 1034, telemetry 1036, and cameras 1038 may be used to provide the system and/or the operator of the ground station with current operating conditions and feedback for commands or controls of the aircraft.

The system 1000 may also include a multi-mode radar system 1040, which may correspond to the multi-mode radar system 117, or any other multi-mode radar system described herein. The multi-mode radar system 1040 includes an array 1041 (which may correspond to the arrays 400, 700, 760, or any other array described herein) and a radar controller 1042 (which may correspond to the radar controller 401, or any other radar controller described herein). The array 1041 may include antenna elements arranged in a two-dimensional array, and may include multiple differently configured arrays having different radar characteristics (e.g., radar bands).

The radar controller 1042 may include hardware and software components to provide the functionality of the multi-mode radar systems described herein. For example, the radar controller 1042 may include transmitter components, receiver components, signal or waveform generators (e.g., to generate the signals that are transmitted by antenna elements operating in a transmit mode), signal processing components, timing and synchronization components, and the like. The radar controller 1042 may be operatively coupled to and cooperate with other systems of an aircraft (e.g., the aircraft computing system 1030, flight management systems 1022, 1023, RGMS 1033, etc.) to change between radar modes. For example, the radar controller 1042 may receive information indicating an aircraft mode, phase, or operation, and select a radar mode based on the information. In some cases, the mode that is selected by the multi-mode radar system for a given mode, phase, or operation may be predetermined (e.g., ground-based transit corresponds to a MIMO mode, transition operations correspond to an alternating mode, and airborne transit corresponds to a pulsed mode).

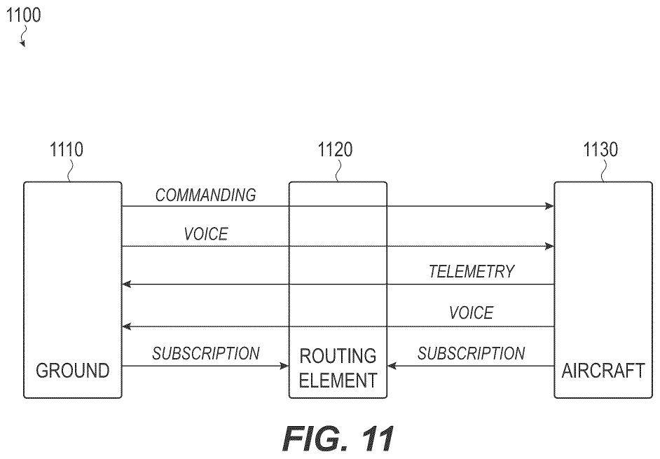

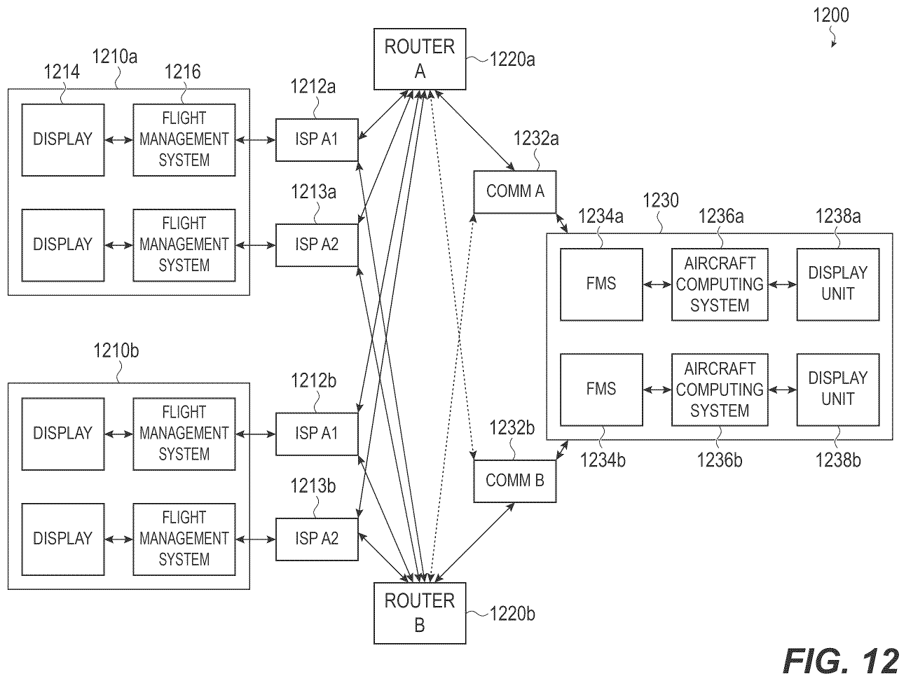

FIG. 11 depicts an example data flow between the ground station and the aircraft. The example system 1100 is a simplified diagram indicating the subscription-based communication scheme implemented by the communication system of the present disclosure. Specifically, the example system 1100 is a simplified example of the communication system 120 of FIG. 1 and may be used for conducting communication in accordance with the system 1200 of FIG. 12. In the example system 1100 of FIG. 11, each of the ground station 1110 and the aircraft 1130 subscribe to messages handled and verified by the routing element 1120. As shown in the system 1100 of FIG. 11, command instructions, voice communication, sensors and other telemetry data are handled using a subscription scheme for directing data between the ground station 1110 and the aircraft 1130.

In one example implementation, the routing element 1120 publishes data packets to all devices having a current subscription. This allows for a flexible architecture that enables a ground station to monitor and control multiple aircraft and also allows for multiple ground stations to monitor and control the same aircraft using the same network elements. Additionally, the subscriptions may be configured to expire on a relatively short time interval, enabling the network configuration to be modified relatively easily while removing non-active network elements to reduce network traffic.

In one example, the ground station 1110 or the aircraft 1130 (the requesting component) transmit a subscription message request to one or more routing elements 1120. In accordance with the requesting component having authenticated credentials that correspond to a cloud-based registry, the requesting component will receive designated messages (from a specified aircraft and/or ground station) for a predetermined period before the subscription expires. In such an implementation, there is no “unsubscribe” message type or need to expressly unsubscribe from a message or data packet set. In one example, the subscriptions expire a subscription period of 30 seconds or greater. In some cases, the subscriptions expire a subscription period of 60 seconds or greater. In some cases, the subscriptions expire a subscription period of 100 seconds or greater. In some cases, the subscriptions expire a subscription period of 300 seconds or greater. In some cases, the subscriptions expire a subscription period of 500 seconds or greater.

To avoid losing an active subscription, the requesting component may submit multiple redundant subscription requests, which may ensure that the subscription is maintained during active operations. In some cases, the requesting component may transmit a subscription request at 2× the expiration rate or greater. In some cases, the requesting component transmits a subscription request at 3×, 4×, 5× or greater of the expiration rate. For example, if a subscription is set to expire after 300 seconds, the requesting component may send a subscription request every 60 seconds in order to have a 5× request rate. In some cases, message transmissions by the respective component (ground station 1110 or aircraft 1130) are interpreted as a concurrent subscription request, which helps to reduce network traffic that would otherwise be generated simply to maintain the subscription. Having a sufficiently high request/transmission rate of, for example, every 60 seconds for a 300 second expiration, allows for some subscription message drops without losing continuous subscription service.

In some implementations, each of the ground station 1110 and the aircraft 1130 address the routers using statically-configured IP addresses. In some implementations, a domain name system (DNS) can be used to enable redirection of network traffic to alternative routing elements without requiring an update to all network components, individually. In some cases, the DNS registry is maintained on a cloud-based resource similar to the cloud-based registry used to authenticate users and system components.

In one example, a transmission from the ground station 1110 includes a tuple or predefined data element that specifies an aircraft identifier and a communication direction flag. The routing element 1120 may maintain a lookup table of subscribers accessible by the same tuple (e.g., {aircraft identifier, direction flag}). When the routing element 1120 receives a message to be forwarded, the routing element 1320 looks up all subscribers for the given tuple ({aircraft identifier, direction flag}) and sends a copy of the message to each subscriber. While this is provided by way of illustrative example, other subscription techniques and registry systems can be used, depending on the implementation.

FIG. 12 depicts an example system for communicating with and controlling an aircraft from a ground station. Specifically, FIG. 12 depicts a system 1200 that allows for uninterrupted communication between one or more ground stations 1210a, 1210b and an aircraft 1230. As described herein, the system 1200 provides a robust system in which any one of a number of components can fail or become unreliable without affecting communications between the ground stations 1210a, 1210b and the aircraft 1230. The system 1200 is also extensible allowing for relatively easy expansion to allow for multiple ground stations to manage or control multiple aircraft without having to provision significantly more network resources or alter the primary architecture.

Similar to previous examples, the system 1200 includes a ground station 1210a having at least one display 1214, one or more flight management systems 1216 and other elements described herein with respect to other ground station examples, such as a route generation and management system. As shown in FIG. 12, each ground station may have similar components and a unique item number for each has been omitted. That is, the second ground station 1210b includes substantially similar components to the first ground station 1210a. Also, similar to previous examples, each ground station is operably coupled to redundant internet service providers 1212a, 1213a for ground station 1210a and 1212b, 1213b for ground station 1210b. In some cases, the internet service providers are a combination of hard wired and wireless internet service providers, which allows for a level of communication medium diversity.

Also similar to previous examples, the aircraft 1230 includes a pair of flight management systems 1234a, 1234b, one or more aircraft computing systems 1236a, 1236b, and one or more display units 1238a, 1238b. The aircraft also includes other various components (e.g., one or more route generation and management systems, flight controllers, etc., which may be part of or instantiated by the aircraft computing systems in some examples), descriptions of which are not repeated for this figure to improve clarity and reduce redundant description. As shown in FIG. 12, the aircraft also includes redundant communication modules 1232a, 1232b. Each of the communication modules 1232a, 1232b is operably coupled to one or both of the routing elements 1220a, 1220b. The connections depicted in dotted lines in FIG. 12 may represent fail-over connections in which the communication modules 1232a, 1232b may be switched between routing elements 1220a, 1220b in response to a reliability condition indicating one of the routing elements 1220a, 1220b may be unable to provide reliable communications.

The system 1200 of FIG. 12 is able to provide ground to air communications for uploading or exchanging routes, flight plans, flight instructions, or other commands directed to the aircraft 1230. The system 1200 is also able to provide air to ground communications including telemetry, camera signals, or other data collected by the aircraft 1230 for access by one of the ground stations 1210a, 1210b. The system 1200 is also able to transmit voice communications between the operator of the ground stations 1210a, 1210b and entities in communication with the aircraft 1230, like air traffic control, other aircraft, or other entities.

The system 1200 may be able to provide at least single-fault reliability in a number of different scenarios. For example, the system 1200 may be able to handle faults on any one of the internet service providers 1212a, 1213a or 1212b, 1213b, any one of the communication modules 1232a, 1232b, any one of the routing elements 1220a, 1220b, as well as any one of the redundant components or subsystems located within the ground stations 1210a, 1210b or the aircraft 1230.

The system 1200 may be configured to operate in using a uniform or designated message format that enables versatile use over a range of data types (commands, voice, telemetry) and enables routing for a variety of fault scenarios. In one example implementation, each message includes a header with (a) an aircraft identifier which may use between 16 and 32 bits, (b) a direction flag, which may be accommodated using 1 bit in which [0] designates messages from the aircraft and [1] designates messages from an ground station, and (c) a message type indicating whether the message is to be forwarded or a subscription request, which may be accommodated using 1 to 32 bits.

Telemetry, commanding, and voice messages are all forwarded by the routing elements 1220a, 1220b. The routing services running on the routing elements 1220a, 1220b are content-agnostic for these messages and the services do not parse the messages or implement any message-specific handling. This reduces the complexity of the routing services and allows the system 1200 to handle a broad range of data types with little or no changes to the architecture. In general, when the routing elements 1220a, 1220b receive any message (to be forwarded for subscription), the routing elements 1220a, 1220b verify that the message signature is valid and that the message was signed by a key referenced in the public key database installed on the router. When receiving a message to be forwarded, the routing elements 1220a, 1220b additionally verify that the signing key is allowed to send messages of this type per the public key database installed on the router, the message is timely (having a timestamp within a threshold of a current time reference), and that the message is strictly ordered with regards to other messages from the same sender or stream identifier. In some cases, the routing elements 1220a, 1220b are also configured to ensure that the message is not a duplicate. Once the routing elements 1220a, 1220b have verified a message to be forwarded, the routing elements 1220a, 1220b add their own signature in addition to the sender's signature. This provides a faster path for revoking sender credentials that does not require updating senders or receivers.

FIG. 13 depicts an example system for authenticating communications and instructions provided by a ground station to an aircraft. Specifically, the system 1300 of FIG. 13 corresponds to the other communication systems described herein but has been simplified to focus on components and services that may be used to ensure secure communications between a ground station 1310 and an aircraft 1330. As described previously, security may be managed by the routing element 1320 alone or in combination with a cloud-based registry 1340.

The system 1300 of FIG. 13 may be used to implement a passive cryptographic routing scheme in which the routing element 1320 is able to verify signatures and example packets but does not need to modify the contents of packets. This enables a fully stateless protocol, which may be beneficial given the network architecture and the likelihood of lost packets, latency, multiple endpoints, and other system characteristics. Alternatively, the systems described herein may include routing elements and a security scheme in which the routing elements are active cryptographic participants in which session-specific encryption keys or schemes are used to encode packets and packet content.

In the system 1300, each sender has a private key that is used to encrypt transmitted messages. As shown in FIG. 13, the ground station 1310 includes a user private key 1312, which may be stored on an electronic device like a smart card that is inserted or otherwise operably coupled to the ground station 1310. Similarly, the aircraft 1330 includes a private key 1332, which may be stored in non-transitory or non-volatile memory on the aircraft computing system or other onboard system. Each routing element 1320 includes its own key 1322, which is used to add a router signature to packets that are processed by the routing element 1320. A database of public keys is also stored on each of the ground station 1310, routing elements 1320, and the aircraft 1330. The database of public keys may be indexed by sender identifier and key identifier and may allow for multiple public keys to allow for key rotation over time.

In a typical operation, each packet sender (the ground station 1310 or the aircraft 1330) may add a sender signature using the corresponding private key, which may be used to validate messages that are transmitted. In some implementations, the routing element 1320 includes a packet authenticating service that verifies the signature of the sender using a local registry 1326 or similar data store. A global registry 1342 or other similar data store may be stored on a cloud-based registry 1340 and used to revoke authority or update local registries of the various system components.

As data packets 1325 are processed by the routing element 1320, the authorization service 1324 may verify the signature of the sender and perform other checks on the packets including timeliness, duplicate packets, packet order, and packet integrity. Additionally, the routing element 1320 may add a routing signature using the routing element key 1322. The recipient can use both the routing signature and the sending signature to validate received messages ensuring the integrity of the data communication.

Entries in the public key databases may be identified by type. The type determines which message types and signature types will be accepted when signed by the corresponding private key. Example types include aircraft messaging types, which may include telemetry and voice data packets; ground station types, which may include commands and voice packets; and router types, which applies to all messages processed by the routing element.

In some implementations, a nested or multiple header scheme is used for transmitted data packets. A first or inner header may include (a) a sender identifier, which may be accommodated using 32 bits, (b) a sender key identifier, which may be accommodated using 8 bits and may also identify a specific public/private key pair associated with the sender identifier, (c) a stream identifier, which may be accommodated using 8 bits, and (d) a timestamp, which may be accommodated using 64 bits and referenced using a universal or synchronized time reference. A second or outer header may include, (a) a sender signature, which may be accommodated using 512 bits and may sign the full message body and the first or inner header, (b) a router identifier, which may be accommodated using 32 bits, (c) a router key identifier, which may be accommodated using 8 bits and may include an identifier of a specific public/private key pair associated with the router, and (d) a router signature, which may be accommodated using 32 bits and may sign the full message body and the first or inner header.

The system 1300 may also maintain multiple keys for each sender, which may allow for older keys to be phased out and replaced with new keys without interrupting service. The cloud-based registry 1340 may also be used to quickly and efficiently revoke access to a user or operator that is no longer authorized by denying access at the router without requiring that all of the public databases at every component of the system be updated to reflect the revoked access. The system 1300 may also include additional security features that may vary depending on the implementation.

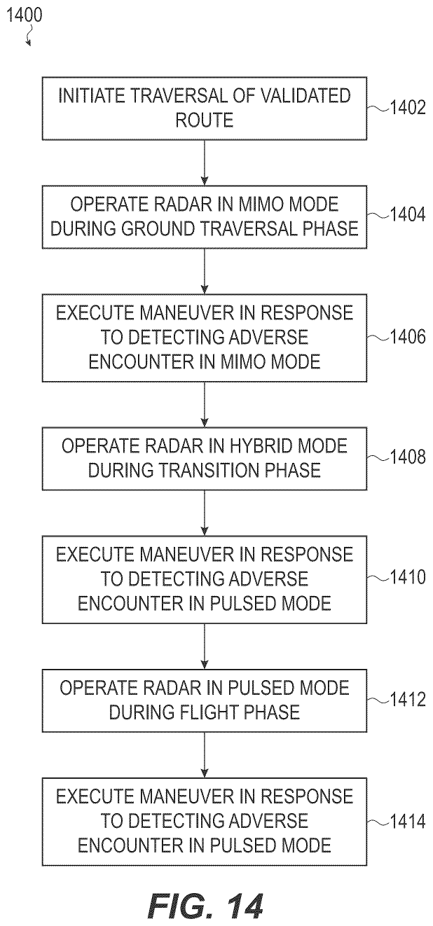

FIG. 14 is a flow chart depicting an example method 1400 of operating a multi-mode radar system. At operation 1402, traversal of a validated route (e.g., a trajectory defined by a validated route) is initiated. As described herein, the validated route may include ground-transit phases, transition phases (e.g., takeoff, landing), and flight phases.

At operation 1404, which may correspond to an autonomous ground transit phase of the validated route (e.g., taxiing), the multi-mode radar system may be operated in a MIMO mode (or other first radar mode). Techniques for operating the multi-mode radar system in the MIMO mode, including how an array of antenna elements is grouped into different subsets to effectuate the MIMO sensing mode, are described herein.

At operation 1406, in response to a prediction of an adverse encounter (e.g., collision, interference, intrusion into an avoidance area, etc.) with an object detected by the multi-mode radar system, the aircraft may execute a ground maneuver or other operation to avoid the adverse encounter. The maneuver or other operation may include a turn, a series of turns, deceleration, acceleration, stopping, or combinations of these (or other) maneuvers.

At operation 1408, which may correspond to an autonomous transition phase of the validated route (e.g., takeoff, landing), the multi-mode radar system may be operated in a hybrid mode that includes at least two radar modes (e.g., MIMO and pulsed). Techniques for operating the multi-mode radar system in the hybrid mode, including how an array of antenna elements is used in different modes (e.g., MIMO, pulsed, FMCW, etc.) and how the multi-mode radar system cycles or alternates among the modes, are described herein.

At operation 1410, in response to a prediction of an adverse encounter (e.g., collision, interference, intrusion into an avoidance area, etc.) with an object detected by the multi-mode radar system, the aircraft may execute a maneuver or other operation to avoid the adverse encounter. During a transition phase, the maneuver or other operation may be selected based on the particular situation of the aircraft at that time, and may include turning, stopping, decelerating, accelerating, changing altitude, aborting a takeoff, aborting a landing, changing a climb or decent rate, or combinations of these (or other) maneuvers.

At operation 1412, which may correspond to an autonomous flight phase of the validated route, the multi-mode radar system may be operated in a pulsed mode (or other second radar mode). Techniques for operating the multi-mode radar system in the pulsed mode are described herein.

At operation 1414, in response to a prediction of an adverse encounter (e.g., collision, interference, intrusion into an avoidance area, etc.) with an object detected by the multi-mode radar system, the aircraft may execute a maneuver or other operation to avoid the adverse encounter. During a flight phase, the maneuver or other operation may include a turn, a series of turns, change in altitude, deceleration, acceleration, or combinations of these (or other) maneuvers.

It will be understood that the operations described with respect to the method 1400 may be performed in different orders, and some operations may be omitted, and some operations that are not specifically described with reference to FIG. 14 may be included.

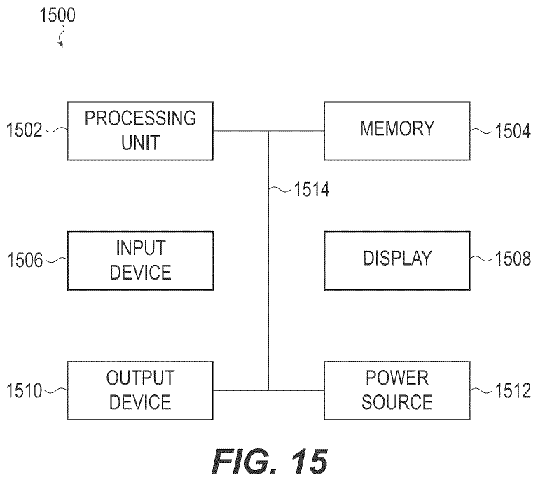

FIG. 15 illustrates a sample electrical block diagram of an electronic device 1500 that may perform the operations described herein. The electronic device 1500 may in some cases take the form of any of the electronic devices described with reference to FIGS. 1-14, including any computing systems, flight controllers, route generation and management systems, ground-based computing systems, aircraft-based or onboard computing systems, radar systems, radar controllers, client devices, servers, or other computing devices associated with the systems described herein and/or used for implementing the techniques described herein. The electronic device 1500 can include one or more of a display 1508, a processing unit 1502, a power source 1512, a memory 1504 or storage device, input devices 1506, and output devices 1510. In some cases, various implementations of the electronic device 1500 may lack some or all of these components and/or include additional or alternative components. Where the electronic device 1500 corresponds to a radar system, the electronic device 1500 may include a radar controller and a radar array (e.g., an array of antenna elements).

The processing unit 1502 can control some or all of the operations of the electronic device 1500. The processing unit 1502 can communicate, either directly or indirectly, with some or all of the components of the electronic device 1500. For example, a system bus or other communication mechanism 1514 can provide communication between the processing unit 1502, the power source 1512, the memory 1504, the input device(s) 1506, and the output device(s) 1510.

The processing unit 1502 can be implemented as any electronic device capable of processing, receiving, or transmitting data or instructions. For example, the processing unit 1502 can be a microprocessor, a central processing unit (CPU), an application-specific integrated circuit (ASIC), a digital signal processor (DSP), or combinations of such devices. As described herein, the term “processing unit” is meant to encompass a single processor or processing unit, multiple processors, multiple processing units, or other suitably configured computing element or elements.

It should be noted that the components of the electronic device 1500 can be controlled by multiple processing units. For example, select components of the electronic device 1500 (e.g., an input device 1506) may be controlled by a first processing unit and other components of the electronic device 1500 (e.g., the display 1508) may be controlled by a second processing unit, where the first and second processing units may or may not be in communication with each other.

The power source 1512 can be implemented with any device capable of providing energy to the electronic device 1500. For example, the power source 1512 may be one or more batteries or rechargeable batteries. Additionally or alternatively, the power source 1512 can be a power connector or power cord that connects the electronic device 1500 to another power source, such as a wall outlet or a power system of the aircraft.

The memory 1504 can store electronic data that can be used by the electronic device 1500. For example, the memory 1504 can store electronic data or content such as, for example, audio files, video files, voice communication packets, documents and applications, device settings and user preferences, computer instructions, timing signals, control signals, and data structures or databases. The memory 1504 can be configured as any type of memory. By way of example only, the memory 1504 can be implemented as random access memory, read-only memory, Flash memory, removable memory, other types of storage elements, or combinations of such devices.

In various embodiments, the display 1508 provides a graphical output, for example associated with an operating system, user interface, and/or applications of the electronic device 1500. For example, the display 1508 may display graphical user interfaces associated with the flight management systems, radar systems, flight controllers, route generation and management systems, or any other graphical user interfaces or other graphical outputs described herein. In one embodiment, the display 1508 includes one or more sensors and is configured as a touch-sensitive (e.g., single-touch, multi-touch) and/or force-sensitive display to receive inputs from a user. For example, the display 1508 may be integrated with a touch sensor (e.g., a capacitive touch sensor) and/or a force sensor to provide a touch- and/or force-sensitive display. The display 1508 is operably coupled to the processing unit 1502 of the electronic device 1500. Additionally or alternatively, the display 1508 may include one or more bezel buttons or other input devices that are arranged along the perimeter of the viewable display area.

The display 1508 can be implemented with any suitable technology, including, but not limited to, liquid crystal display (LCD) technology, light emitting diode (LED) technology, organic light-emitting display (OLED) technology, organic electroluminescence (OEL) technology, or another type of display technology.

In various embodiments, the input devices 1506 may include any suitable components for detecting inputs. For example, the input device 1506 may include a keyboard, mouse, trackpad, or other similar type of input device configured to receive typing, cursor control, or other user input. In some cases, an input device may be an inceptor or other input system that can receive directional inputs, such as a directional pad, thumbstick, or the like. In some cases, a separate tablet or other portable electronic device may include a touch screen or touch sensor that can be adapted for use as an input device 1506 for the device 1500. Other examples of input devices 1506 include, without limitation, gaming controllers, light sensors, temperature sensors, audio sensors (e.g., microphones), optical or visual sensors (e.g., cameras, visible light sensors, or invisible light sensors), proximity sensors, touch sensors, force sensors, mechanical devices (e.g., switches, buttons, or keys), airspeed sensors, altimeters, accelerometers, tilt sensors, radar sensors, LiDAR sensors, vibration sensors, orientation sensors, motion sensors (e.g., accelerometers or velocity sensors), location sensors (e.g., global positioning system (GPS) devices), thermal sensors, communication devices (e.g., wired or wireless communication devices), resistive sensors, magnetic sensors, or electrodes. Each input device 1506 may be configured to detect one or more particular types of input and provide a signal (e.g., an input signal) corresponding to the detected input. The signal may be provided, for example, to the processing unit 1502.

As discussed above, in some cases, the input device(s) 1506 include a touch sensor (e.g., a capacitive touch sensor) integrated with the display 1508 to provide a touch-sensitive display. Similarly, in some cases, the input device(s) 1506 include a force sensor (e.g., a capacitive force sensor) integrated with the display 1508 to provide a force-sensitive display. Additionally or alternatively, the input device(s) 1506 may include a separate trackpad, mouse, tablet, or other device configured to receive touch and/or force input from the user.

The output devices 1510 may include any suitable components for providing outputs. Examples of output devices 1510 include, without limitation, light emitters, audio output devices (e.g., speakers), visual output devices (e.g., lights or displays), tactile output devices (e.g., haptic output devices), and communication devices (e.g., wired or wireless communication devices). Each output device 1510 may be configured to receive one or more signals (e.g., an output signal provided by the processing unit 1502) and provide an output corresponding to the signal.

In some cases, input devices 1506 and output devices 1510 are implemented together as a single device. For example, an input/output device or port can transmit electronic signals via a communications network, such as a wireless and/or wired network connection. Examples of wireless and wired network connections include, but are not limited to, the example communication systems described herein and include, without limitation, satellite communication systems, cellular systems, Wi-Fi, Bluetooth, IR, or Ethernet connections.

The processing unit 1502 may be operably coupled to the input devices 1506 and the output devices 1510. The processing unit 1502 may be adapted to exchange signals with the input devices 1506 and the output devices 1510. For example, the processing unit 1502 may receive an input signal from an input device 1506 that corresponds to an input detected by the input device 1506. The processing unit 1502 may interpret the received input signal to determine whether to provide and/or change one or more outputs in response to the input signal. The processing unit 1502 may then send an output signal to one or more of the output devices 1510, to provide and/or change outputs as appropriate.

Where the electronic device 1500 is a radar system, the electronic device 1500 may also include transmitters, receivers, signal generators, signal processors, amplifiers, filters, analog-to-digital converters, radio circuitry, and the like.

Unless otherwise stated, the terms “include” and “comprise” (and variations thereof such as “including,” “includes,” “comprising,” “comprises,” “comprised” and the like) are used inclusively and do not exclude further features, components, integers, steps, or elements.

It will be understood that the embodiments disclosed and defined in this specification extend to alternative combinations of two or more of the individual features mentioned in or evident from the text or drawings. All of these different combinations constitute alternative embodiments of the present disclosure.

The present specification describes various embodiments with reference to numerous specific details that may vary from implementation to implementation. No limitation, element, property, feature, advantage or attribute that is not expressly recited in a claim should be considered as a required or essential feature. Accordingly, the specification and drawings are to be regarded in an illustrative rather than a restrictive sense.

What is claimed is:

1. A method of operating a multi-mode radar system during multiple phases of autonomous aircraft operation, comprising:
at an aircraft configured for autonomous operations and comprising a multi-mode radar system, the multi-mode radar system comprising a two-dimensional array of antenna elements:
during an autonomous taxiing phase, operating the multi-mode radar system in a first radar mode to detect ground-based objects, including:
operating a first subset of the two-dimensional array of antenna elements and a second subset of the two-dimensional array of antenna elements in a transmit mode, the first subset of the two-dimensional array of antenna elements different from the second subset of the two-dimensional array of antenna elements; and
while operating the first and the second subsets of the two-dimensional array of antenna elements in the transmit mode, operating a third subset of the two-dimensional array of antenna elements and a fourth subset of the two-dimensional array of antenna elements in a receive mode, the third subset of the two-dimensional array of antenna elements different from the fourth subset of the two-dimensional array of antenna elements;
based at least in part on a first set of signals received by the third subset and the fourth subset of the two-dimensional array of antenna elements, detecting a first position of a ground-based object;
in response to a prediction of a collision between the ground-based object and the aircraft, the prediction based at least in part on the first position of the ground-based object, executing a ground maneuver to change a direction of travel of the aircraft over ground;
during an autonomous flight phase, operating the multi-mode radar system in a second radar mode to detect airborne objects, including:
operating the two-dimensional array of antenna elements in the transmit mode for a first duration; and
after the first duration, operating the two-dimensional array of antenna elements in the receive mode for a second duration;
based at least in part on a second set of signals received by the two-dimensional array of antenna elements when operating in the receive mode, detecting a second position of an airborne object; and
in response to a prediction of a collision between the airborne object and the aircraft, the prediction based at least in part on the second set of signals, executing a flight maneuver to change a direction of flight of the aircraft.

2. The method of claim 1, further comprising, during an autonomous takeoff phase, alternating between operating the multi-mode radar system in the first radar mode and operating the multi-mode radar system in the second radar mode.

3. The method of claim 1, wherein:
the method further comprises, during the autonomous taxiing phase, causing the aircraft to traverse a predefined trajectory over ground; and
the prediction of the collision between the ground-based object and the aircraft is based at least in part on a determination that the predefined trajectory intersects at least one of the first position of the ground-based object or a predicted future position of the ground-based object.

4. The method of claim 3, wherein:
the predefined trajectory is a predefined first trajectory;
the method further comprises:
after detecting the first position of the ground-based object, detecting a third position of the ground-based object; and
determining a second trajectory of the ground-based object based at least in part on the first position of the ground-based object and the third position of the ground-based object; and
the predicted future position of the ground-based object is determined based at least in part on the second trajectory of the ground-based object.

5. The method of claim 1, wherein:
the first subset of the two-dimensional array of antenna elements comprises a first one-dimensional array of antenna elements; and
the second subset of the two-dimensional array of antenna elements comprises a second one-dimensional array of antenna elements.

6. The method of claim 5, wherein:
operating the first one-dimensional array in the transmit mode includes transmitting, with the first one-dimensional array, a first signal having a first waveform; and
operating the second one-dimensional array in the transmit mode includes transmitting, with the second one-dimensional array, a second signal having a second waveform different from the first waveform.

7. The method of claim 5, wherein:
the third subset of the two-dimensional array of antenna elements comprises a third one-dimensional array of antenna elements; and
the fourth subset of the two-dimensional array of antenna elements comprises a fourth one-dimensional array of antenna elements.

8. A method of operating a multi-mode radar system during multiple phases of autonomous aircraft operation, comprising:
at an aircraft configured for autonomous operations and comprising a multi-mode radar system, the multi-mode radar system comprising an array of antenna elements:
during an autonomous ground transit phase, operating the multi-mode radar system in a first radar mode to detect ground-based objects, including:
causing a first subset of the array of antenna elements to emit a first signal;
causing a second subset of the array of antenna elements to emit a second signal different from the first signal, the second subset of the array of antenna elements different from the first subset of the array of antenna elements; and
while the first subset of the array of antenna elements are emitting the first signal and while the second subset of the array of antenna elements are emitting the second signal:
receiving, with a third subset of the array of antenna elements, first reflected portions of the first and second signals; and
receiving, with a fourth subset of the array of antenna elements, second reflected portions of the first and second signals, the fourth subset of the array of antenna elements spatially separated from the third subset of the array of antenna elements;
detecting a first position of a ground-based object based at least in part on the first reflected portions and the second reflected portions of the first and second signals;
changing at least one of a speed or a direction of the aircraft over ground during the autonomous ground transit phase based at least in part on the first position of the ground-based object;
during an autonomous flight phase, operating the multi-mode radar system in a second radar mode to detect airborne objects, including:
causing the array of antenna elements to emit a third signal;
causing the array of antenna elements to cease emitting the third signal; and
while the array of antenna elements has ceased emitting the third signal, receiving, with the array of antenna elements, a reflected portion of the third signal;
detecting a second position of an airborne object based at least in part on the reflected portion of the third signal; and
changing at least one of a speed or a direction of the aircraft through the air during the autonomous flight phase based at least in part on the second position of the airborne object.

9. The method of claim 8, wherein changing at least one of a speed or a direction of the aircraft over ground during the autonomous ground transit phase occurs in response to a determination that a trajectory of the aircraft over ground intersects the ground-based object.

10. The method of claim 9, wherein changing at least one of a speed or a direction of the aircraft through the air during the autonomous flight phase occurs in response to a determination that a trajectory of the aircraft through the air intersects the ground-based object.

11. The method of claim 8, wherein the first signal has a first waveform, and the second signal has a second waveform different from the first waveform.

12. The method of claim 8, wherein:
operating the multi-mode radar system in the first radar mode further includes, while the first subset of the array of antenna elements are emitting the first signal and while the second subset of the array of antenna elements are emitting the second signal:
receiving, with a fifth subset of the array of antenna elements, third reflected portions of the first and second signals; and
receiving, with a sixth subset of the array of antenna elements, fourth reflected portions of the first and second signals.

13. The method of claim 8, further comprising, during an autonomous takeoff phase, alternating between operating the multi-mode radar system in the first radar mode and operating the multi-mode radar system in the second radar mode.

14. The method of claim 13, further comprising, during an autonomous landing phase, alternating between operating the multi-mode radar system in the first radar mode and operating the multi-mode radar system in the second radar mode.

15. The method of claim 8, wherein:
the second position specifies a distance between the aircraft and the airborne object; and
the method further comprises:
during the autonomous flight phase, in accordance with a determination that the distance between the aircraft and the airborne object satisfies a distance condition, transitioning from operating the multi-mode radar system in the second radar mode to operating the multi-mode radar system in the first radar mode; and
detecting a second position of the airborne object with the multi-mode radar system in the first radar mode.

16. A multi-mode radar system for an autonomous aircraft, comprising:
a radar array comprising a two-dimensional array of antenna elements arranged in a set of rows and a set of columns; and
a radar controller coupled to the two-dimensional array of antenna elements and configured to operate the radar array according to a first radar mode during an autonomous ground transit phase and according a second radar mode during an autonomous flight phase, wherein:
operating the radar array according to the first radar mode comprises:
causing at least a portion of a first column of antenna elements within the two-dimensional array of antenna elements to emit a first signal;
causing at least a portion of a second column of antenna elements within the two-dimensional array of antenna elements to emit a second signal;
while the first and second signals are being emitted:
receiving, with at least a portion of a third column of antenna elements within the two-dimensional array of antenna elements, a first reflected portion of the first signal and a first reflected portion of the second signal; and
receiving, with at least a portion of a fourth column of antenna elements within the two-dimensional array of antenna elements, a second reflected portion of the first signal and a second reflected portion of the second signal; and
detecting, based at least in part on a time difference of arrival of the first reflected portion of the first signal and the second reflected portion of the first signal, a first position of a ground-based object relative to the multi-mode radar system; and
operating the radar array according to the second radar mode comprises:
causing the two-dimensional array of antenna elements to emit a third signal;
causing the two-dimensional array of antenna elements to cease emitting the third signal;
while the two-dimensional array of antenna elements has ceased emitting the third signal, receiving, with the two-dimensional array of antenna elements, a reflected portion of the third signal; and
detecting a second position of an airborne object relative to the multi-mode radar system based at least in part on the reflected portion of the third signal.

17. The multi-mode radar system of claim 16, wherein the first column of antenna elements is adjacent the second column of antenna elements.

18. The multi-mode radar system of claim 17, wherein the third column of antenna elements is adjacent the fourth column of antenna elements.

19. The multi-mode radar system of claim 16, wherein operating the radar array according to the first radar mode further comprises:
while the first and second signals are being emitted:
receiving, with at least a portion of a fifth column of antenna elements within the two-dimensional array of antenna elements, third reflected portions of the first and second signals; and
receiving, with at least a portion of a sixth column of antenna elements within the two-dimensional array of antenna elements, fourth reflected portions of the first and second signals.

20. The multi-mode radar system of claim 19, wherein, while the first and second signals are being emitted, a portion of the antenna elements within the two-dimensional array of antenna elements are neither emitting nor receiving signals.
